(19) United States
(12) Patent Application Publication
(10) Pub. No.: US 2025/0144676 A1
(43) Pub. Date: May 8, 2025

(54) Pressure Washer

(71) Applicant: Greenworks (Jiangsu) Co., Ltd, Changzhou (CN)

(72) Inventors: Chunlin Zhao, Changzhou (CN); Jun Zhang, Changzhou (CN); Hailong Huang, Changzhou (CN)

(21) Appl. No.: 19/017,853

(22) Filed: Jan. 13, 2025

Related U.S. Application Data
(63) Continuation of application No. PCT/CN2023/106773, filed on Jul. 11, 2023.

(30) Foreign Application Priority Data
Jul. 14, 2022 (CN) 202210834065.0
Oct. 20, 2022 (CN) 202222774813.9
Dec. 2, 2022 (CN) 202211535549.1
Jun. 19, 2023 (CN) 202310728151.8

(51) Int. Cl. B08B 3/02; B08B 13/00

(52) U.S. Cl. CPC B08B 3/026; B08B 13/00; B08B 2203/0211; B08B 2203/0223; B08B 2203/0235

(57) ABSTRACT

A pressure washer includes a lower bracket assembly, an upper bracket assembly, a power head assembly and a washing assembly. The power head assembly includes a housing assembly, a motor pump assembly, a battery pack cavity and a driving assembly. The housing assembly includes a lower housing, an upper housing, a battery pack cavity and a cover. The motor pump assembly is accommodated in a first accommodating cavity formed by assembling the upper housing and the lower housing. The battery pack assembly is accommodated in the battery pack cavity and includes at least two battery packs connected in series or in parallel. The driving assembly includes a water-cooled driver to drive the motor pump assembly to work and a circuit controller electrically connected with the battery pack assembly to access a power of each battery pack and distribute it to the water-cooled driver.

### CROSS REFERENCE TO RELATED APPLICATION

The present application is a continuation Application of PCT application No. PCT/CN2023/106773 filed on Jul. 11, 2023, which claims the benefit of CN202210834065.0 filed on Jul. 14, 2022, CN202222774813.9 filed on Oct. 20, 2022, CN202211535549.1 filed on Dec. 2, 2022, and CN202310728151.8 filed on Jun. 19, 2023. All the above are hereby incorporated by reference for all purposes.

### TECHNICAL FIELD

The disclosure relates to a pressure washer, belonging to a technical field of washing devices.

### BACKGROUND

High-pressure pressure washers are mainly used for cleaning courtyards, fences, vehicles, etc. The conventional handheld gun-type DC pressure washers on the market are generally equipped with a low-voltage battery. Due to the low voltage and small capacity of the battery, when working in DC mode, the power of the machine is quite small, the water pressure and flow rate of the machine are very small, the battery life is also very short, and the cleaning effect is very poor and can only meet some light cleaning conditions such as floating layers. It basically cannot meet work conditions that require moderate or deep cleaning.

In addition, in the conventional high-pressure pressure washers, the battery pack assembly, the motor pump, the controller unit, the switch electrical unit and the casing protection unit are all dispersedly arranged, which enables the pressure washer to be relatively large in size and relatively complex in structure. Moreover, after installation, these structures can only be used for the current pressure washer and cannot be disassembled for other power devices, such as lawn mowers, etc., so that users need to buy a variety of different types of power equipment, resulting in a sharp increase in costs.

In view of this, it is necessary to improve the conventional hand-held gun-type DC pressure washer to solve the problems mentioned above.

### SUMMARY

One of more embodiments provide a pressure washer. A total power, operating time and battery life of the pressure washer have been improved, and a power head assembly may be installed as an independent and movable device on a power device such as pressure washers or mowers, which meets various needs of different applications.

One of more embodiments provide a pressure washer. The pressure washer includes a lower bracket assembly, an upper bracket assembly extending upward from the lower bracket assembly, a power head assembly fixed on the lower bracket assembly, and a washing assembly connected with the upper bracket assembly. The power head assembly includes a housing assembly, a motor pump assembly, a battery pack assembly and a driving assembly.

The housing assembly includes a lower housing, an upper housing assembled with the lower housing, a battery pack cavity at least partially accommodated in the upper housing and a cover covering a top of the battery pack cavity.

The motor pump assembly is accommodated in a first accommodating cavity formed by assembling the upper housing and the lower housing.

The battery pack assembly is accommodated in the battery pack cavity, the battery pack cavity includes at least two battery packs connected in series or in parallel.

The driving assembly includes a water-cooled driver and a circuit controller below the housing assembly, the water-cooled driver is electrically connected with the motor pump assembly in the lower housing to drive the motor pump assembly to work, and the circuit controller is electrically connected with the battery pack assembly to access a power of each battery pack and distribute the power to the water-cooled driver.

Further, the upper housing and the lower housing are further assembled to form a second accommodating cavity and a third accommodating cavity, the battery pack cavity is accommodated in the second accommodating cavity and the third accommodating cavity to accommodate the at least two battery packs, the first accommodating cavity is located between the second accommodating cavity and the third accommodating cavity, the battery pack cavity includes a first accommodating part accommodated in the second accommodating cavity, a second accommodating part accommodated in the third accommodating cavity, and a connecting part connecting the first accommodating part and the second accommodating part, and the first accommodating cavity is formed below the connecting part and separates the first accommodating part from the second accommodating part.

Further, a power switch and a mode switch are arranged at a middle position of the upper housing, the power switch is configured to control an on-off of the power head assembly, and the mode switch is configured to provide a variety of working modes to the power head assembly, and the working modes include an energy-saving mode and/or a high-power mode.

Further, there are two covers and the covers are respectively installed in a flipping manner on two side edges of the upper housing, each of the covers is provided with a flipping rotation shaft and flipping springs sleeved on both ends of the flipping rotation shaft, when the cover is opened, the flipping rotation shaft rotates synchronously and causes the flipping spring to be stretched, and after the cover is released, the flipping spring drives the cover to close automatically.

Further, a first pressing block and a second pressing block are arranged at a center position of the flipping rotation shaft, a damper and a power-off switch are correspondingly arranged in the upper housing, the first pressing block is configured to preferentially contact the damper when the cover is automatically closed, and the second pressing block is configured to abut against the power-off switch to turn on the power-off switch when the cover is in a closed state and configured to be disconnected from the power-off switch to turn off the power-off switch when the cover is in an open state.

Further, the motor pump assembly includes a brushless motor, a pump head assembly connected with the brushless motor, and a first water inlet pipeline and a second water inlet pipeline connected with two ends of the brushless motor, the first water inlet pipeline is arranged away from the pump head assembly to connect with external water, and the second water inlet pipeline connects the brushless motor with the pump head assembly on a side of the brushless motor close to the pump head assembly.

Further, the water-cooled driver is electrically connected with the brushless motor on one side of the first water inlet pipeline, a cooling passage is formed inside the brushless motor, and the cooling passage flows through the water-cooled driver and the brushless motor at the same time, so that the external water enters through the first water inlet pipeline, passes through the cooling passage first, and then flows into the pump head assembly from the second water inlet pipeline.

Further, the cooling passage includes a first cooling passage formed between the water-cooled driver and the brushless motor and a second cooling passage located inside the brushless motor, the second cooling passage communicate the first cooling passage with the second water inlet pipeline, the first cooling passage is arranged in a spiral shape, and the second cooling passage is arranged in a ring shape.

Further, the motor pump assembly includes a brushless motor, the brushless motor includes an outer housing, a stator assembly and a rotor assembly, the stator assembly and the rotor assembly are arranged in the outer housing, the outer housing is sealed, an accommodating space is formed in the outer housing, and the accommodating space contains insulating liquid to absorb heat generated by the brushless motor and transfer the heat to an outer surface of the outer housing.

Further, a volume of the insulating liquid accounts for 95% or more of a volume of the accommodating space.

Further, the brushless motor further includes an exhaust valve, the exhaust valve is arranged on the outer housing and communicated with the accommodating space, and a valve port for the exhaust valve is arranged on the outer housing.

Further, the exhaust valve includes a first valve body, a first sealing ring, a second sealing ring, a steel ball and an elastic component, the first valve body is embedded in the valve port, the first sealing ring is sleeved on an outside of the first valve body to seal and connect the first valve body with the outer housing, the steel ball is arranged inside the first valve body, the second sealing ring is located between the steel ball and the first valve body to seal an internal space of the first valve body, and the elastic component abuts against the steel ball along an exhaust direction of the exhaust valve.

Further, the pump head assembly includes a pump head and a gun-shutdown switch, and the pump head is configured to receive clean water flowing in from the second water inlet pipeline and to increase a pressure.

Further, the gun-shutdown switch includes a gun-shutdown unloading valve, and the gun-shutdown unloading valve includes a second valve body, a first elastic unit, hydraulic cavity, and a switch unit.

The second valve body includes a valve sleeve and a valve rod, and the valve rod is movably arranged relative to the valve sleeve between a first station and a second station.

The first elastic unit is configured such that an elastic force pf the first elastic unit acts between the valve rod and the valve sleeve and keeps the valve rod in the first station.

The hydraulic cavity is formed between the valve rod and the valve sleeve, a first flow hole penetrating to the hydraulic cavity is arranged on the valve rod, and when fluid medium in the hydraulic cavity reaches a preset pressure, the valve rod is capable of overcoming the elastic force of the first elastic unit and moving to the second station.

The switch unit is provided with a trigger part, the trigger part is configured to be triggered by the valve rod, and when the valve rod switches between the first station and the second station, the trigger part is capable of changing an open state and a closed state of the switch unit.

Further, the valve sleeve is provided with a second flow hole and a third flow hole, an unloading valve core located between the second flow hole and the third flow hole is arranged inside the valve sleeve, the unloading valve core is coupled to the valve rod, when the valve rod is located at the first station, the unloading valve core remains in a closed state, and when the valve rod moves from the first station to the second station, the unloading valve core can be switched to an open state.

Further, an annular groove is arranged on an inner wall of the valve sleeve, the second flow hole and the third flow hole are respectively located at two ends of the annular groove, the unloading valve core is located in the annular groove, a second elastic unit is arranged on a side of the unloading valve core away from the valve rod, the second elastic unit is configured so that an elastic force of the second elastic unit is driving the unloading valve core to cling to a groove wall of the annular groove close to the valve rod so as to block a flow passage between the second flow hole and the third flow hole, a valve needle is arranged on an end of the valve rod facing the unloading valve core, and when the valve rod moves from the first station to the second station, the valve needle is capable of driving the unloading valve core to be separated from the groove wall of the annular groove so as to communicate the flow passage between the second flow hole and the third flow hole.

Further, the valve needle is movably connected with the valve rod along an axis direction thereof, and a third elastic unit is arranged between the valve needle and the valve rod.

Further, the switch unit includes a micro switch, the trigger part includes a driving rod of the micro switch, the valve rod abuts against the driving rod, and the driving rod and the valve rod are assembled so that when the valve rod is located at the first station, the micro switch is closed, and when the valve rod is located at the second station, the micro switch is disconnected.

Beneficial effects of one or more embodiments of the disclosure are as follows: the pressure washer not only improves the total power and the operating time by configuring the battery pack assembly to include at least two battery packs connected in series or in parallel, but also may further improve the battery life by replacing the battery pack. In addition, through integrating the housing assembly, the motor pump assembly, the battery pack assembly and the driving assembly into a whole, it is designed into an independently movable power head assembly, so that it may be installed on different applications at any time to meet various needs depending on the usage conditions, thereby expanding a scope of use.

### BRIEF DESCRIPTION OF THE DRAWINGS

FIG. 1 is a perspective view of a pressure washer according to at least one embodiment of the disclosure.

FIG. 2 is an exploded view of the pressure washer in FIG. 1.

FIG. 3 is an exploded view of a power head assembly in FIG. 2.

FIG. 4 is an exploded view of the housing assembly in FIG. 3.

FIG. 5 is a partial exploded view of an upper housing in FIG. 4.

FIG. 6 is a perspective view of a cover in FIG. 4.

FIG. 7 is a perspective view of a motor pump assembly in FIG. 3 according to at a first embodiment of the disclosure.

FIG. 8 is a cross-sectional view of FIG. 7.

FIG. 9 is a perspective view of the motor pump assembly in FIG. 7 from another angle.

FIG. 10 is a partial schematic structural view of FIG. 9.

FIG. 11 is a schematic view of FIG. 10 from another angle.

FIG. 12 is a diagram of an internal wiring and an electrical schematic view of each electrical components in the power head assembly according to at least one embodiment of the disclosure.

FIG. 13 is a schematic structural view of the motor pump assembly according to a second embodiment of the disclosure.

FIG. 14 is a schematic structural view of the motor pump assembly in FIG. 13 after removing a driving assembly.

FIG. 15 is a cross-section view of the motor pump assembly in FIG. 13.

FIG. 16 is a cross-section view of the motor pump assembly in FIG. 13 from another angle.

FIG. 17 is an enlarged view of an A area in FIG. 16.

FIG. 18 is a partial cross-section view of the motor pump assembly in FIG. 13.

FIG. 19 is a cross-section view of a first cooling passage in FIG. 14.

FIG. 20 is a perspective view of a pump head assembly according to at least one embodiment of the disclosure.

FIG. 21 is an exploded view of the pump head assembly in FIG. 20.

FIG. 22 is a front view of the pump head assembly in FIG. 20.

FIG. 23 is a cross-sectional view taken along line A-A of FIG. 22.

FIG. 24 is a cross-sectional view taken along line B-B of FIG. 23.

FIG. 25 is a cross-sectional view taken along line C-C of FIG. 23.

FIG. 26 is an exploded view of a second valve body in FIG. 21.

FIG. 27 is a circuit principle view of a gun-shutdown unloading valve according to at least one embodiment of the disclosure.

FIG. 28 is a schematic structural view of the motor pump assembly according to a third embodiment of the disclosure.

FIG. 29 is a top view of the motor pump assembly in FIG. 28.

FIG. 30 is a cross-sectional view taken along line A-A of FIG. 29.

FIG. 31 is a cross-sectional view taken along line B-B of FIG. 29.

FIG. 32 is a cross-sectional view taken along line C-C of FIG. 29.

FIG. 33 is a partial exploded view of a brushless motor in FIG. 28.

FIG. 34 is a perspective view of the brushless motor in FIG. 28.

FIG. 35 is a cross-sectional view of an adapter in FIG. 28.

### DETAILED DESCRIPTION

In order to enable the objectives, technical solutions and advantages of the disclosure to be clearer, the disclosure is described in detail below with reference to the accompanying drawings and specific embodiments.

The disclosure provides a pressure washer 100 for use in a field of household cleaning. It may be used for cleaning courtyards, fences, vehicles, etc., and may also be used in outdoor conditions without a power supply, such as high-pressure cleaning of tableware after picnics, docks, ships, yachts, etc.

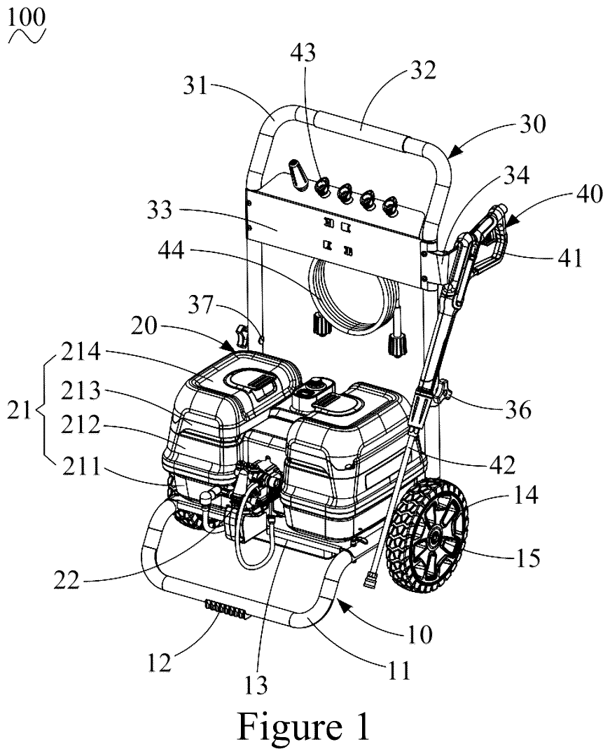

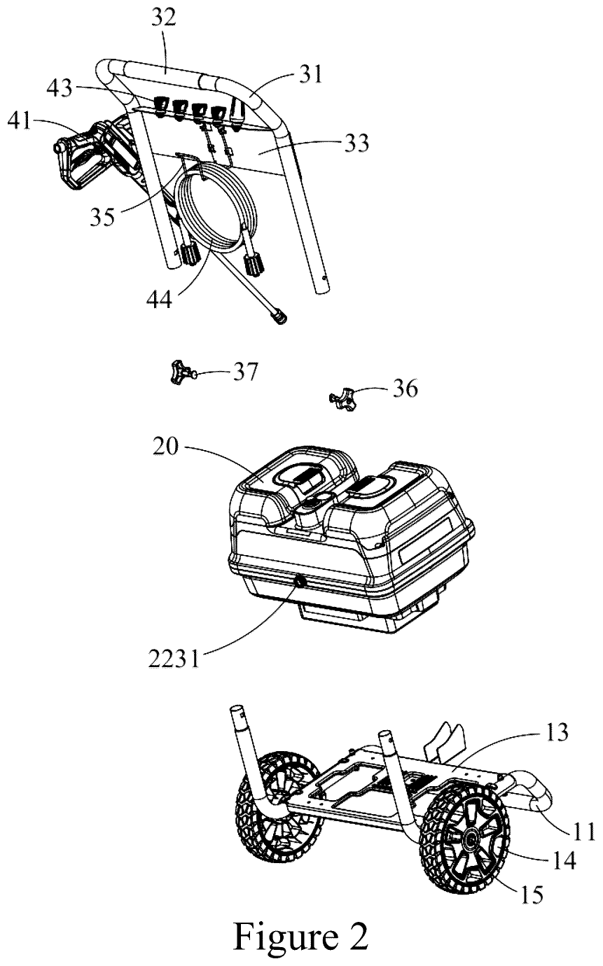

Please refer to FIG. 1 and FIG. 2. The pressure washer 100 includes a lower bracket assembly 10, a power head assembly 20 fixed on the lower bracket assembly 10, an upper bracket assembly 30 extending upward from the lower bracket assembly 10 and a washing assembly 40 connected with the upper bracket assembly 30.

The lower bracket assembly 10 can be used as a mounting base for the power head assembly 20 and can also be used as a support for pushing the pressure washer 100 to move. In an embodiment, the lower bracket assembly 10 includes a lower bracket 11, a bracket pad 12, a mounting bottom plate 13, a walking wheel 14 and a screw 15. Wherein, the bracket pad 12 is arranged at a middle position of a bottom of the lower bracket 11, and is used to prevent the lower bracket 11 from slipping when contacting a ground, so that the pressure washer 100 can be stably placed on the ground. The power head assembly 20 is installed and fixed on the mounting bottom plate 13. The walking wheel 14 is assembled and fixed to the lower bracket 11 by screws 15. There are two walking wheels 14 and they are arranged on two sides of the lower bracket 11, which can not only support the pressure washer 100, but also drive the pressure washer 100 to walk.

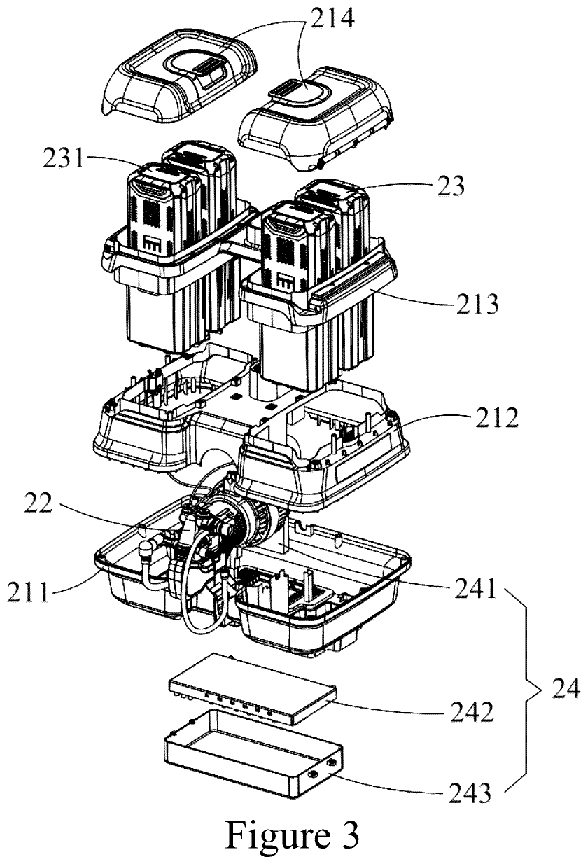

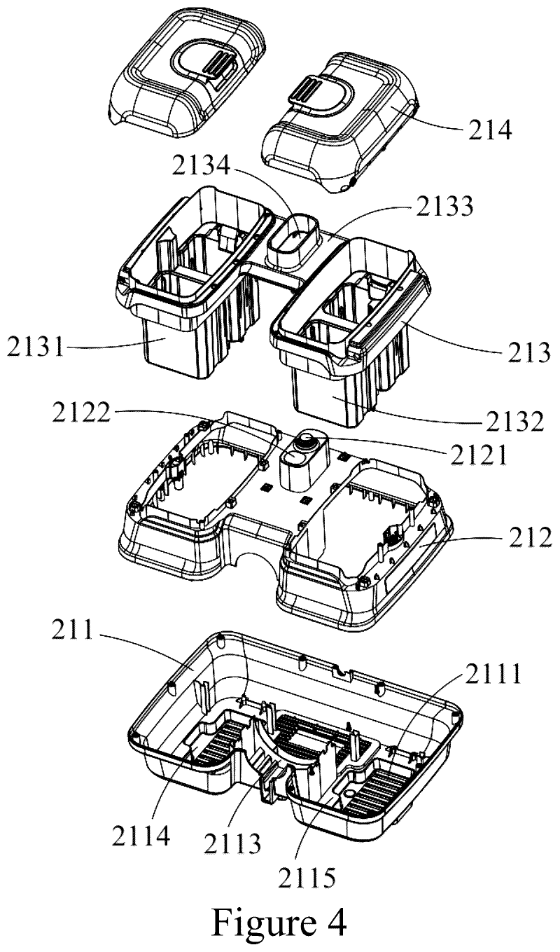

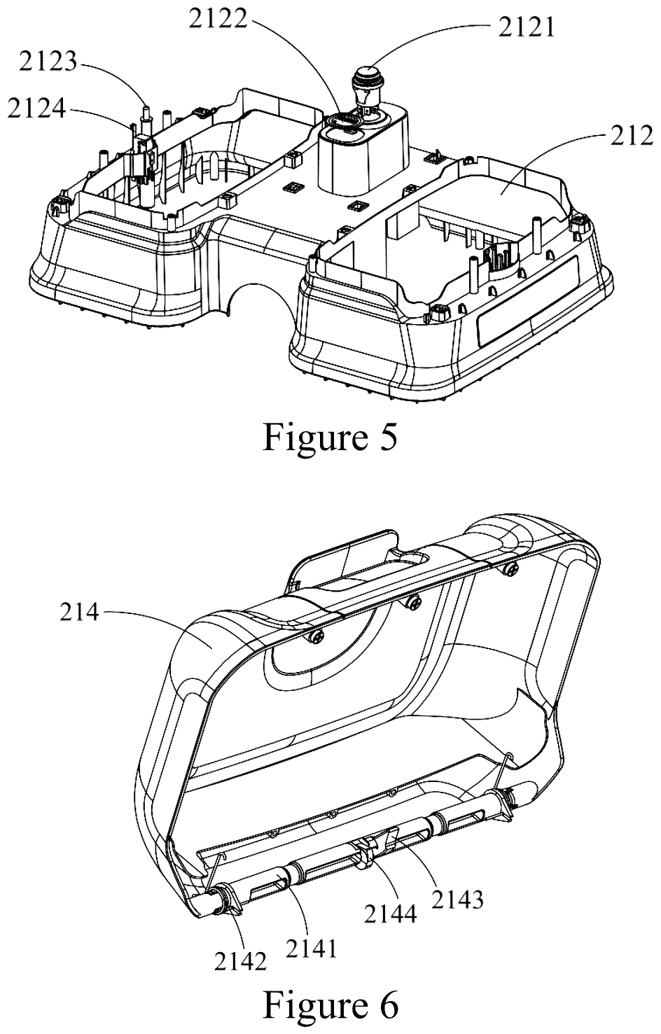

Please refer to FIG. 3 through FIG. 6 in conjunction with FIG. 1. The power head assembly 20 can not only provide a powerful and efficient cleaning performance for the pressure washer 100, but also provide a water cooling and heat dissipation for a motor pump assembly 22 and a driving assembly 24, and can further provide a strong power supply for the motor pump assembly 22. The power head assembly 20 includes a housing assembly 21, the motor pump assembly 22, a battery pack assembly 23 and the driving assembly 24. Wherein, the housing assembly 21 includes a lower housing 211, an upper housing 212 assembled with the lower housing 211, a battery pack cavity 213 at least partially accommodated in the upper housing 212 and a cover 214 covering a top of the battery pack cavity 213.

Specifically, the lower housing 211 is concave in shape, and a plurality of through holes 2111 is provided at a bottom of the lower housing 211. The through holes 2111 penetrate the lower housing 211, so that an inner cavity of the lower housing 211 is communicated with an outside. The upper housing 212 is also concavely arranged and is assembled and fixed with the lower housing 211 by screws. After the upper housing 212 and the lower housing 211 are assembled, a first accommodating cavity 2113, a second accommodating cavity 2114 and a third accommodating cavity 2115 are formed. Wherein, the first accommodating cavity 2113 is located between the second accommodating cavity 2114 and the third accommodating cavity 2115. The motor pump assembly 22 is accommodated in the first accommodating cavity 2113 and extends out of the housing assembly 21 from the first accommodating cavity 2113. The battery pack cavity 213 is accommodated in the second accommodating cavity 2114 and the third accommodating cavity 2115 and extends out of the housing assembly 21 from the second accommodating cavity 2114 and the third accommodating cavity 2115. An arrangement of the through holes 2111 enables heat generated by the battery pack assembly 23 in the battery pack cavity 213 to be dissipated through the through hole 2111.

A power switch 2121 and a mode switch 2122 are arranged at a middle position of the upper housing 212. Wherein, the power switch 2121 is configured to control an on-off of the power head assembly 20, and the mode switch 2122 is configured to provide a variety of working modes to the power head assembly 20. For example, to extend the battery life of the power head assembly 20, the mode switch 2122 may be used as an energy-saving switch (ECO mode) to reduce power which means that by pressing this switch, the motor pump assembly 22 can operate at a preset low-power gear to increase the battery life. The mode switch 2122 may also be used as a high-function switch (TURBO mode) to increase power and enhance cleaning effectiveness for a short time, which means that by pressing this switch, the motor pump assembly 22 may operate for a short time at a preset high-power gear, and output a higher water pressure or flow with higher power to achieve better cleaning results. Of course, the above two working modes may also be set at the same time to enhance user's experience in different conditions. It should be noted that, this disclosure only shows schemes of the above-mentioned energy-saving working mode, but should not be limited to this.

In the energy-saving mode (ECO mode), a total power of the power head assembly 20 is not less than 1.8 KW, a working pressure is not less than 10 MPa, and a flow rate is not less than 450 L/H. At this time, when a user is dealing with low difficulty cleaning work, the pressure washer 100 can operate at a lower power in a low-gear mode to increase its working time. Under a short-time (less than 30 SEC) working mode of high power (TURBO), the power head assembly 20 may output a larger pressure (not less than 20 MPa) with higher power, providing users with a variety of selectable working conditions, which means conditions requiring medium cleaning (10 MPa), conditions with high difficulty in cleaning (18 MPa), and conditions with stubborn cleaning (20 MPa), basically achieving a full replacement of the usage conditions of gasoline pressure washers.

The second accommodating cavity 2114 and the third accommodating cavity 2115 are respectively arranged on two sides of the upper housing 212 and the lower housing 211. The battery pack cavity 213 includes a first accommodating part 2131 accommodated in the second accommodating cavity 2114, a second accommodating part 2132 accommodated in the third accommodating cavity 2115, and a connecting part 2133 connecting the first accommodating part 2131 and the second accommodating part 2132. The first accommodating cavity 2113 is formed below the connecting part 2133 and separates the first accommodating part 2131 and the second accommodating part 2132. That is to say, the battery pack cavity 213 is arranged in an H shape as a whole, with the connecting part 2133 located in a middle, and the first accommodating part 2131 and the second accommodating part 2132 located on the two sides. This reduces a volume of the housing assembly 21, enables an internal space layout of the housing assembly 21 to be more compact and a space occupancy rate to be higher. A cavity 2134 is arranged on the connecting part 2133 to expose the power switch 2121 and the mode switch 2122, thereby facilitating the user to operate the power switch 2121 and the mode switch 2122.

The battery pack assembly 23 is installed in the first accommodating part 2131 and the second accommodating part 2132 of the battery pack cavity 213. The battery pack assembly 23 includes one or more detachable battery packs 231. The plurality of detachable battery packs 231 may be connected in series and/or in parallel to convert a power supply voltage into a working voltage of the motor pump assembly 22. In an embodiment, this disclosure adopts a design of four large-capacity battery packs (80 V/5 AH), so that the total power is guaranteed to be greater than 800 WH, a minimum operating time is greater than 15 min, and the battery life may be further improved by replacing the battery pack 231. In this embodiment, the four battery packs 231 are connected in parallel to power the entire pressure washer 100. Of course, in other embodiments, other connection methods may also be used to power the pressure washer 100, such as: the plurality of low-voltage battery packs 231 are connected in series to supply power, or the plurality of battery packs 231 are connected in series and in parallel to supply power, which will not be repeated here.

Two covers 214 are arranged and are respectively installed on the two side edges of the upper housing 212 in a flipping manner to expose the first accommodating part 2131 and the second accommodating part 2132 of the battery pack cavity 213, thereby facilitating an insertion or removal of the battery pack 231. Each of the covers 214 is provided with a flipping rotation shaft 2141 and flipping springs 2142 sleeved on both ends of the flipping rotation shaft 2141, when the cove 214 is opened, the flipping rotation shaft 2141 rotates synchronously and causes the flipping springs 2142 to be stretched, and after the cover 214 is released, the flipping spring 2142 drives the cover 214 to close automatically. In this embodiment, the cover 214 may be opened to an angle of 90-100 degrees by the flipping rotation shaft 2141 to facilitate the insertion or the removal of the battery pack 231. The flipping spring 2142 is a torsion spring. When the cover 214 is released, the cover 214 may be automatically closed by a reaction force of the torsion springs arranged at two ends of the flipping rotation shaft 2141.

In order to avoid collision sound generated by the cover 214 and the battery pack cavity 213 when closing, the disclosure provides a damper 2123 in the upper housing 212. The damper 2123 may first contact the first pressing block 2143 arranged at a middle position of the flipping rotation shaft 2141 before the cover 214 contacts the battery pack cavity 213, so as to reduce a closing speed of the cover 214 and eliminate the collision sound. At the same time, the second pressing block 2144 arranged at a middle position of the flipping rotation shaft 2141 may enable the power-off switch 2124 arranged on the upper housing 212 to close again, so that a circuit is in a conductive state. Specifically, the first pressing block 2143 and the second pressing block 2144 are arranged at a center position of the flipping rotation shaft 2141, and the damper 2123 and the power-off switch 2124 are correspondingly provided in the upper housing 212. The first pressing block 2143 is configured to preferentially contact the damper 2123 when the cover 214 is automatically closed, so as to eliminate the collision sound generated by the flipping spring 2142 and the battery pack cavity 213 when the cover 214 is automatically closed, thereby providing a better user experience. The second pressing block 2144 is configured to abut against the power-off switch 2124 when the cover 214 is in the closed state, so that the power-off switch 2124 is turned on, and the second pressing block 2144 is configured to disconnect from the power-off switch 2124 when the cover 214 is in an open state, so that the power-off switch 2124 is disconnected and the pressure washer 100 stops working immediately. This arrangement may ensure a safety of the user and prevent personal injury due to someone reaching into the battery pack cavity 213 and touching a charged object when the cover 214 is in the open state.

In some embodiments, the first pressing block 2143 is protruding in a triangular shape on the flipping rotation shaft 2141. The power-off switch 2124 is a micro switch. The second pressing block 2144 is provided with a contacting surface (not labeled) abutting against the micro switch 2124, so that the second pressing block 2144 and the micro switch 2124 are in a surface contact, and a contacting stability is better.

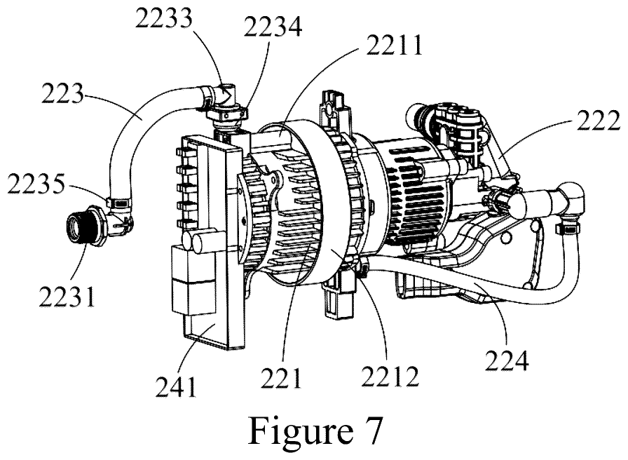

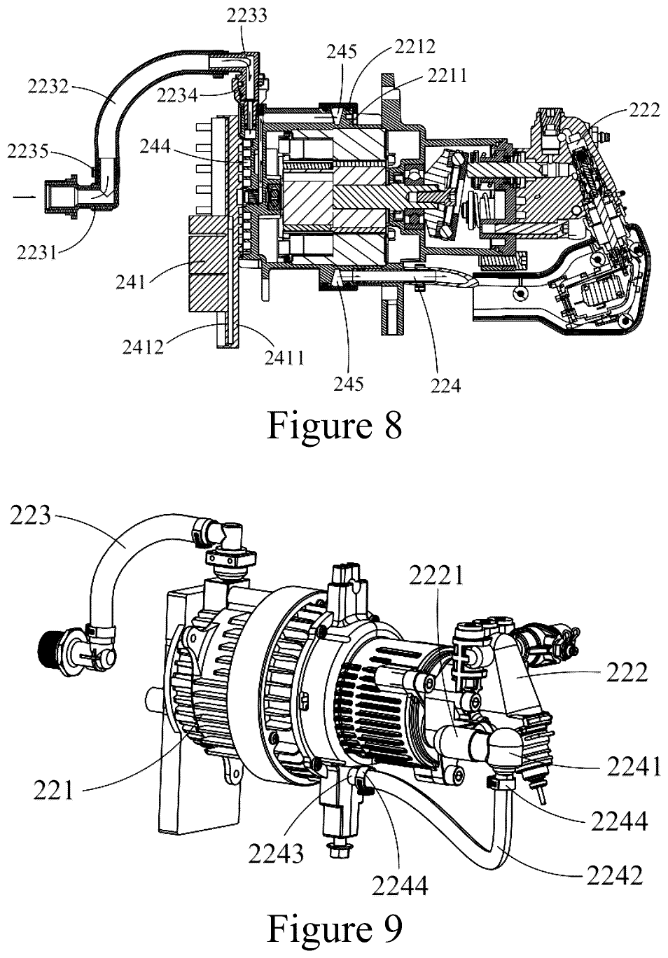

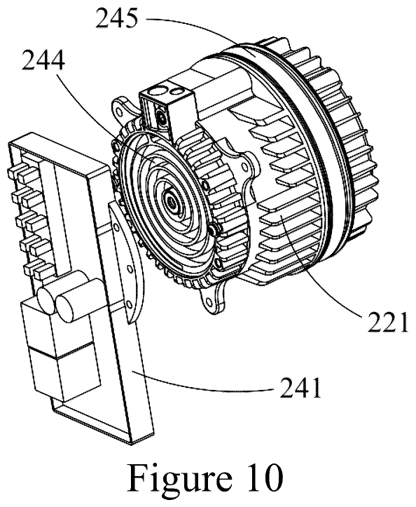

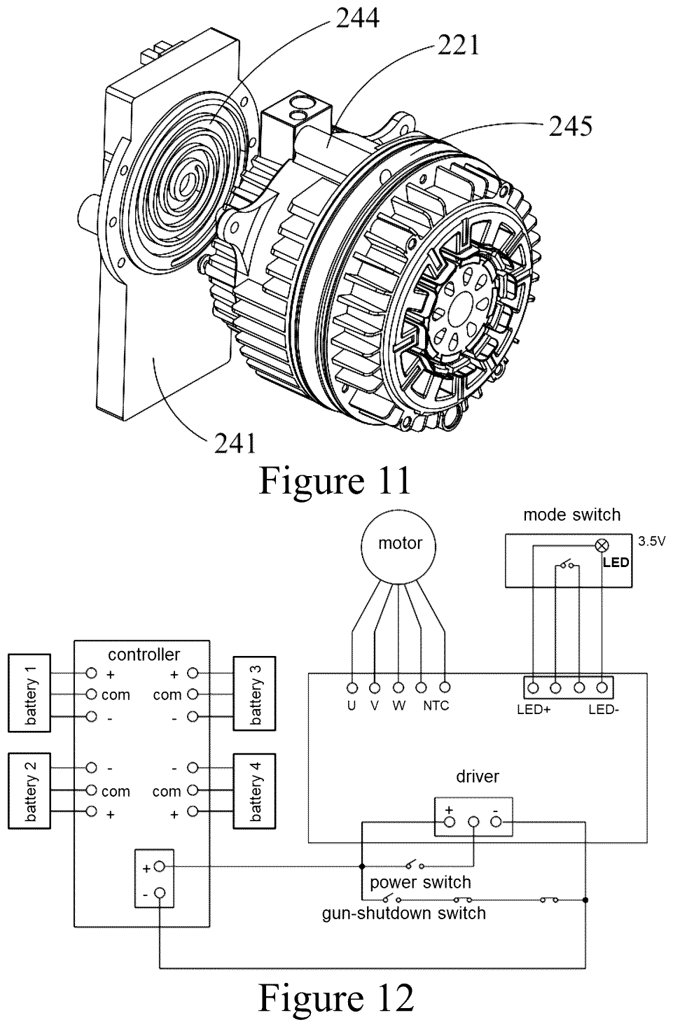

Please refer to FIG. 7 through FIG. 11 in conjunction with FIG. 3. The motor pump assembly 22 includes a brushless motor 221, a pump head assembly 222 connected with the brushless motor 221, and a first water inlet pipeline 223 and a second water inlet pipeline 224 connected with two ends of the brushless motor 221. Wherein, the brushless motor 221 is arranged between the pump head assembly 222 and the driving assembly 24 and respectively connected with the pump head assembly 222 and the drive assembly 24. The pump head assembly 222 is used to receive input from an external water source, the brushless motor 221 is used to provide power to the pump head assembly 222 and increase a pressure of the pump head assembly 222 by doing work, and the driving assembly 24 is used to drive the brushless motor 221 to work. The first water inlet pipeline 223 is arranged away from the pump head assembly 222 to connect to the external water source. The second water inlet pipeline 224 connects the brushless motor 221 with the pump head assembly 222 on a side of the brushless motor 221 close to the pump head assembly 222.

The first water inlet pipeline 223 includes a first water inlet connector 2231, a first water inlet hose 2232, a second water inlet connector 2233 and a third water inlet connector 2234. Two ends of the first water inlet hose 2232 are respectively connected with the first water inlet connector 2231 and the second water inlet connector 2233 by a pipe clamp 2235. The second water inlet connector 2233 is connected with the third water inlet connector 2234 by a U-shaped clamping pin. The third water inlet connector 2234 is connected with the outer housing 2211 of the brushless motor 221 by a threaded seal. With such a design, a water inlet of the pressure washer 100 may be arbitrarily arranged at an appropriate position of the housing assembly 21 through a flexible connection of the water inlet. The second water inlet pipeline 224 includes a fourth water inlet connector 2241, a second water inlet hose 2242 and a water inlet tube 2243. Two ends of the second water inlet hose 2242 are also connected with the fourth water inlet connector 2241 and the water inlet pipe 2243 through pipe clamps 2244 respectively. The fourth water inlet connector 2241 is communicated with the water inlet 2221 of the pump head assembly 222.

The driving assembly 24 includes a water-cooled driver 241 accommodated in the lower housing 211, a circuit controller 242 located below the housing assembly 21, and a controller cover casing 243 for protecting the circuit controller 242. The water-cooled driver 241 is electrically connected with the motor pump assembly 22 in the lower housing 211 to drive the motor pump assembly 22 to work. The circuit controller 242 is electrically connected with the battery pack assembly 23 to access a power of each battery pack 231 and distribute it to the water-cooled driver 241. The controller cover casing 243 is arranged on an outside of a bottom of the lower housing 211, and the circuit controller 242 is accommodated in the controller cover casing 243, which can collect and organize signals from multiple battery packs 231 and the power switch 2121, and distribute a DC power supply to the water-cooled driver 241 and the brushless motor 221, so that the brushless motor 221 may work according to a predetermined working procedure.

The water-cooled driver 241 is electrically connected with the brushless motor 221 on one side of the first water inlet pipeline 223, a cooling passage is formed inside the brushless motor 221, and the cooling passage flows through the water-cooled driver 241 and the brushless motor 221 at the same time, so that the external water enters through the first water inlet pipeline 223, passes through the cooling passage first, then flows into the pump head assembly 222 from the second water inlet pipeline 224 and then takes away heat generated during an operation of the water-cooled driver 241 and the brushless motor 221, thus playing a role in heat dissipation.

The cooling passage includes a first cooling passage 244 formed between the water-cooled driver 241 and the brushless motor 221 and a second cooling passage 245 located inside the brushless motor 221. In this embodiment, the first cooling passage 244 is arranged on an axial side surface of the outer housing 2211, and the first cooling passage 244 is arranged in a spiral shape. The second cooling passage 245 is arranged in an annular shape, and the second cooling passage 245 communicates the first cooling passage 244 with the second water inlet pipeline 224. In this way, after the external water source cools a heat sink 2411 and the brushless motor 221 on the water-cooled driver 241 through the first cooling passage 244 and the second cooling passage 245, it may enter the pump head assembly 222 through the second water inlet pipeline 224, then be continuously sucked and pressurized by the pump head assembly 222, and finally sprayed onto a surface to be cleaned through high-pressure and large-flow water output to complete a cleaning work. A side of the brushless motor 221 towards the motor pump assembly 22 is an output end, and another axial end of the brushless motor 221 is a rear end. The heat sink 2411 is fixedly arranged in contact with the outer housing 2211, and the heat sink 2411 is arranged on the water-cooled driver 241.

When the brushless motor 221 is running, the pump head assembly 222 utilizes a suction action of the pump to allow the external water to first enter the first cooling passage 244 located between the outer housing 2211 of the brushless motor 221 and the heat sink 2411 through the first water inlet pipeline 223, then enter the second cooling passage 245 located between the outer housing 2211 of the brushless motor 221 and the motor cover 2212, and then enter the water inlet 2221 of the pump head assembly 222 through the second water inlet pipeline 224. After being pressurized by a high-pressure water pump, the external water is output from a water outlet end of the pump head assembly 222 to a high-pressure water tube 44, a gun barrel assembly 42, and s spray nozzle 43, and finally sprayed onto the surface to be cleaned through high-pressure and large-flow water to complete the cleaning work.

During an operation of the motor pump assembly 22, a MOS transistor on a circuit board 2412 of the water-cooled driver 241 will generate heat when working and transfer it to the heat sink 2411 closely attached to the MOS transistor. A coil of the brushless motor 221 will also generate a large amount of heat and transfer it to the outer housing 2211 closely attached to the coil. When the external water source continuously passes through the above first cooling passage 244 and second cooling passage 245, the heat sink 2411, the outer housing 2211, etc. of the water-cooled driver 241 may be synchronously cooled by water to eliminate the heat generated by the MOS transistor and other heating elements on the water-cooled driver 241 and the coil of the brushless motor 221 during operation, so that the power head assembly 20 can work safely, continuously and efficiently.

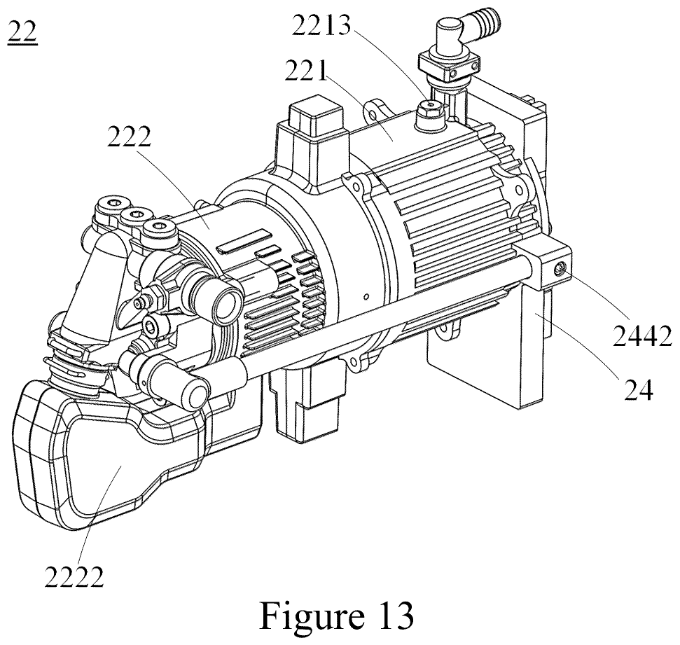

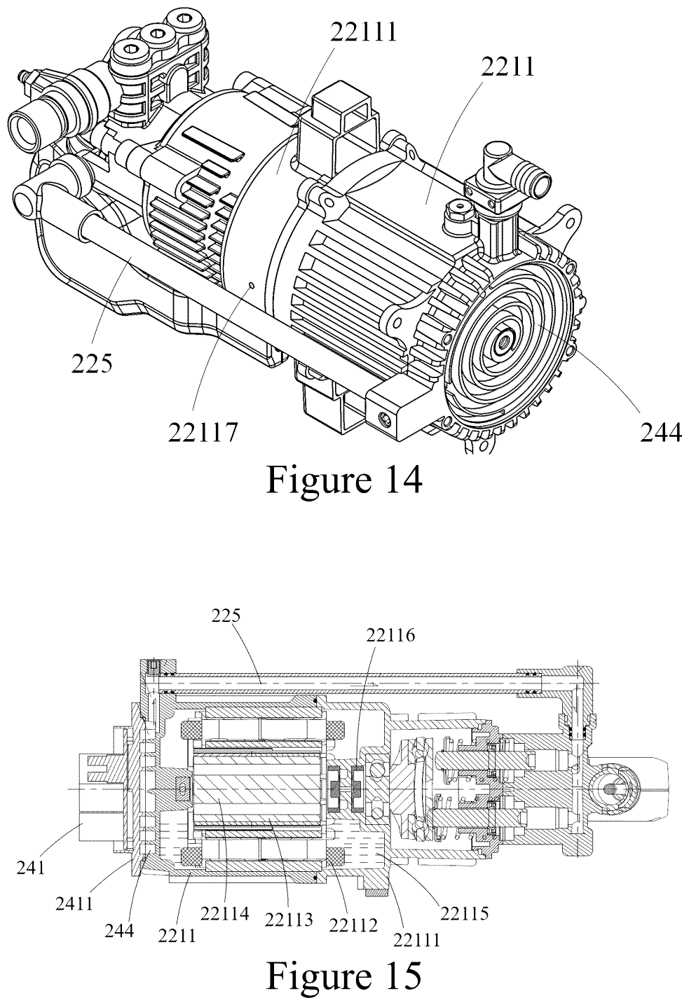

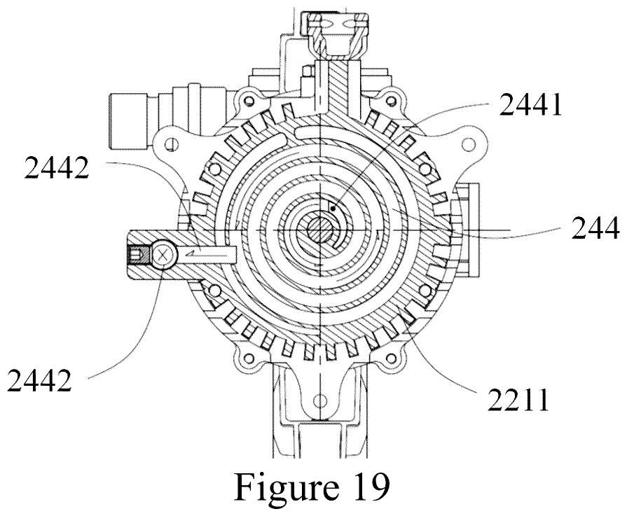

Please refer to FIG. 13 through FIG. 19. They show another embodiment of the motor pump assembly 22. In this embodiment, the brushless motor 221 includes the outer housing 2211, a front end cover 22111, a stator assembly 22112, a rotor assembly 22113 and a motor shaft 22114. Wherein, the stator assembly 22112, the rotor assembly 22113 and the motor shaft 22114 are all accommodated inside the outer housing 2211. The first cooling passage 244 is enclosed to define a planar structure, and the planar structure is perpendicular to an extending direction of the motor shaft 22114. The first cooling passage 244 is provided with a water inlet 2441 and a water outlet 2442, and the water inlet 2441 and the water outlet 2442 of the first cooling passage 244 are both arranged along a radial direction of the planar structure. When the external water flows in from the water inlet 2441 of the first cooling passage 244, the external water will fill the first cooling passage 244, and the heat on the heat sink 2411 and the outer housing 2211 will continue to be transferred to the water in the first cooling passage 244, and discharged from the water outlet 2442 of the first cooling passage 244 as the external water continues to flow, thereby taking away the heat generated by the water-cooled driver 241 and the brushless motor 221 during operation, and achieving a heat dissipation effect. Water source outputted from the water outlet 2442 of the first cooling passage 244 may be inputted into the pump head assembly 222 and reused.

The second water inlet pipeline 224 is parallel to an axial extending direction of the rotor assembly 22113, and the second water inlet pipeline 224 is respectively connected with the pump head assembly 222 and the first cooling passage 244, which means that the water inlet of the second water inlet pipeline 224 is communicated with the water outlet 2442 of the first cooling passage 244, and the water outlet of the second water inlet pipeline 224 is communicated with the pump head assembly 222.

The outer housing 2211 is connected with the driving assembly 24, the front end cover 22111 is connected with the pump head assembly 222, and the outer housing 2211 and the front end cover 22111 are connected and sealed. The motor shaft 22114 passes through rotation centers of the outer housing 2211 and the front end cover 22111 respectively, the stator assembly 22112 is fixedly arranged on an inner wall of the outer housing 2211, and the rotor assembly 22113 is sleeved on an outer circumference of the motor shaft 22114.

In some embodiments, the outer housing 2211 is sealed, an accommodating space is formed between the outer housing 2211 and the front end cover 22111, and the stator assembly 22112, the rotor assembly 22113 and the motor shaft 22114 are all accommodated in the accommodating space. Insulating liquid 22115 is also arranged in the accommodating space. The insulating liquid 22115 is preferably oil, and a volume of the insulating liquid 22115 accounts for 95% or more of a volume of the accommodating space, so that the insulating liquid 22115 may quickly take away the heat generated by the coil.

When the motor pump assembly 22 is running, since the coils of the stator assembly 22112 are all immersed in the insulating liquid 22115, the heat generated by the coils may be fully taken away by the insulating liquid 22115. At the same time, the insulating liquid 22115 is in a full contact with the outer housing 2211, and heat of the insulating liquid 22115 is also fully conducted to a surface of the outer housing 2211. The heat conducted to the outer housing 2211 is then taken away by the external water source of the first cooling passage 244 that forms a seal with the outer housing 2211, so that a temperature of the coil may be effectively reduced.

In this embodiment, the motor shaft 22114 is arranged through the front end cover 22111, and a rotating oil sealing 22116 is arranged between the motor shaft 22114 and the front end cover 22111. In this embodiment, two rotating oil sealings 22116 are arranged. One of the rotating oil sealings is arranged close to the outer housing 2211, and the other one of the rotating oil sealings is arranged close to the pump head assembly 222. A closed cavity is formed between the motor shaft 22114, the rotating oil sealing 22116 and the front end cover 22111. A draining hole 22117 communicated with the closed cavity is opened on an outer wall of the front end cover 22111. The draining hole 22117 extends radially along the motor shaft 22114.

When the motor pump assembly 22 is running, lubricating oil in a front oil cylinder of the front end cover 22111 may penetrate into the closed cavity, and the insulating liquid 22115 in the accommodating space may also penetrate into the closed cavity. When oil that penetrates from front and rear ends cannot be removed in time, a pressure in the closed cavity will increase, causing the oil that enters the closed cavity and then enters the accommodating space, contamination of the insulating liquid 22115, and the brushless motor 221 to fail or cause other faults. An arrangement of the draining hole 22117 may effectively discharge the oil that has penetrated into the closed cavity.

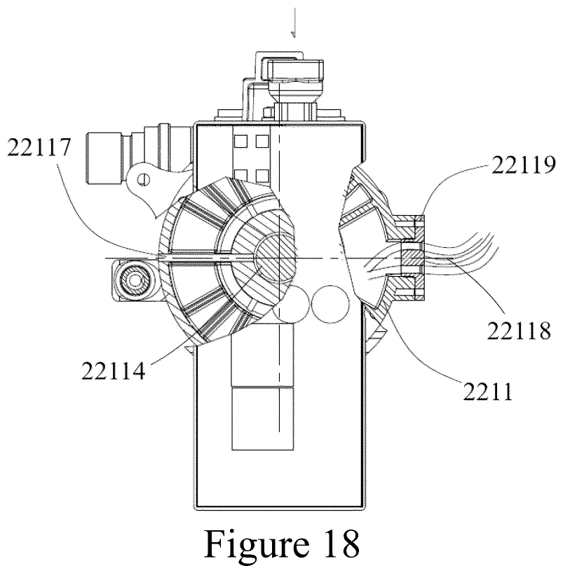

Please refer to FIG. 18. A sealing block 22119 is arranged on an outer side wall of the front end cover 22111. A guiding wire 22118 of the stator assembly 22112 forms a seal with the sealing block 22119 after passing through a threading hole on the sealing block 22119. The sealing block 22119 also forms a seal with the front end cover 22111. In this way, an internal space of the brushless motor 221 may be completely sealed.

For a wire output and sealing method of the brushless motor 221, other structures may also be used. For example, a plastic wiring box is designed, multiple double-threaded wiring posts are designed inside the wiring box, and flame-retardant polyurethane potting glue is injected into the wiring box to achieve a complete sealing on two sides of the wiring box. A sealing ring is sleeved on an outside of the wiring box to realize a mechanical seal with the outer housing. The guiding wires led out from the coil are connected with the wiring posts on an inside of the wiring box with screws. The wiring posts on an outside of the wiring box are respectively connected with other structures with connecting wires. This connecting method is easy to operate, and connection and sealing methods are more reliable. Such a design may effectively prevent the insulating liquid 22115 from leaking outward from a gap between core wires of the connecting wires led out of the coil.

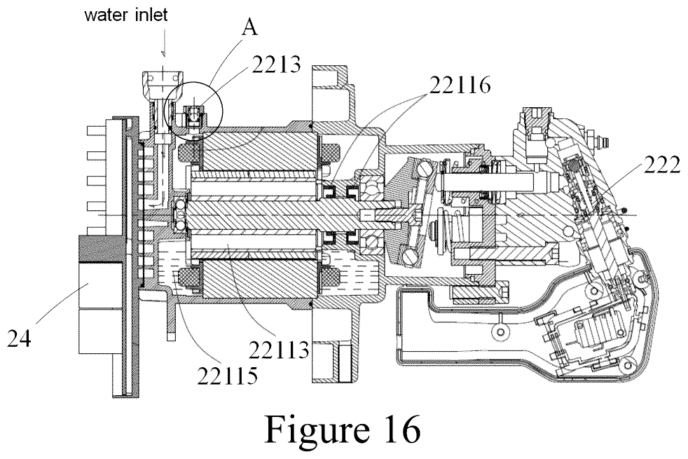

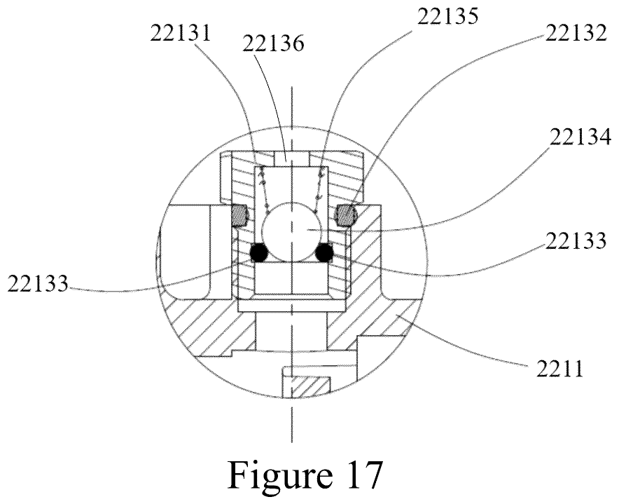

Please refer to FIG. 13, FIG. 16 and FIG. 17. The brushless motor 221 further includes an exhaust valve 2213, which is arranged on the outer housing 2211 and provided with a valve port for installing the exhaust valve 2213. The exhaust valve 2213 is communicated with the accommodating space.

The exhaust valve 2213 includes a first valve body 22131, a first sealing ring 22132, a second sealing ring 22133, a steel ball 22134 and an elastic component 22135. The first valve body 22131 is embedded in the valve port. A top of the first valve body 22131 is provided with an exhaust hole 22136, which is communicated with outside air. The first sealing ring 22132 is sleeved on an outside of the first valve body 22131 to seal and connect the first valve body 22131 with the outer housing 2211. The steel ball 22134 is arranged inside the first valve body 22131, the second sealing ring 22133 is located between the steel ball 22134 and the first valve body 22131 to seal an internal space of the first valve body 22131, and the elastic component 22135 abuts against the steel ball 22134 along an exhaust direction of the exhaust valve 2213. The elastic component 22135 is a spring in some embodiments. During exhaust, gas pushes the steel ball 22134 to move toward the exhaust hole 22136 in the first valve body 22131, so that the elastic component 22135 is compressed. After the exhaust is completed, the elastic component 22135 pushes the steel ball 22134 to return to its original position under an action of its own elastic force, thereby closing the exhaust valve 2213.

Specifically, during the operation of the motor pump assembly 22, air in the accommodating space expands due to heat, and an air pressure will increase. When the air pressure reaches a sum of the pre-tightening force of the elastic component 22135 and a weight of the steel ball 22134, the pressurized air will push the steel ball 22134 open and overflow from the exhaust hole 22136 on the first valve body 22131, thereby reducing the pressure in the accommodating space to ensure sealing safety.

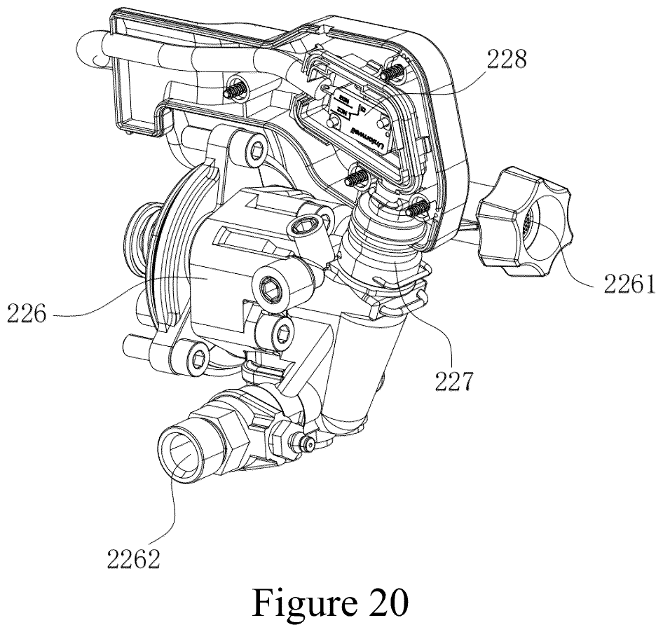

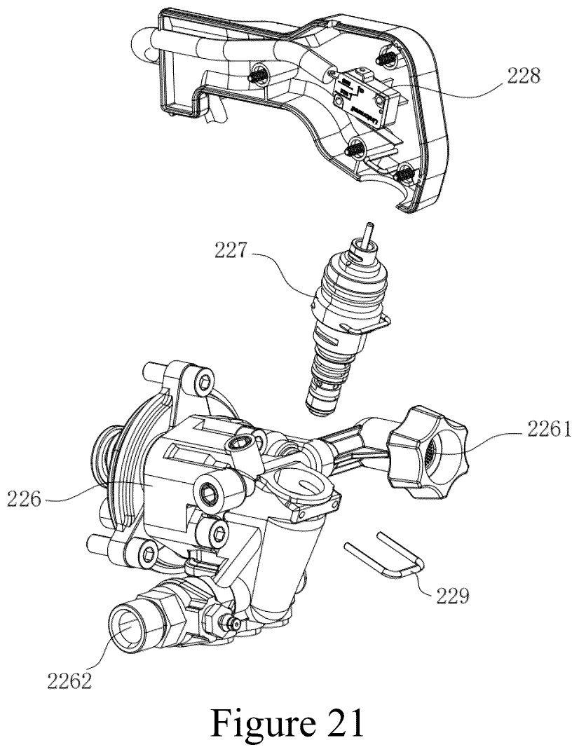

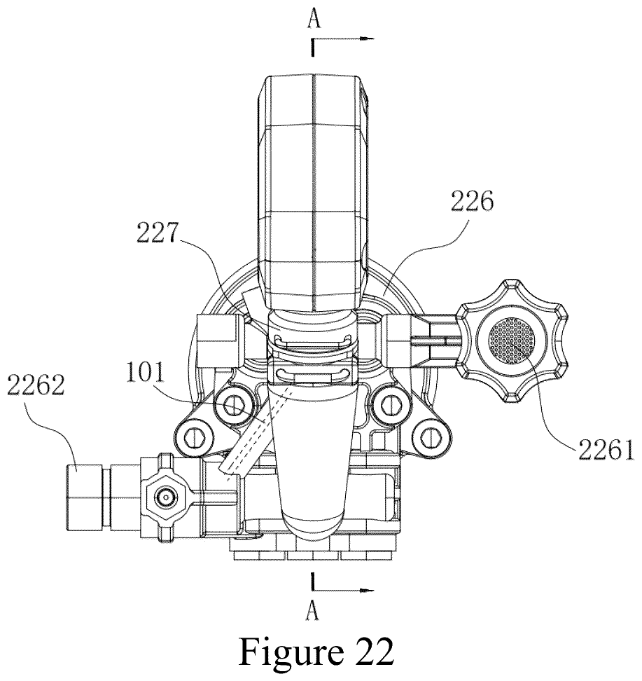

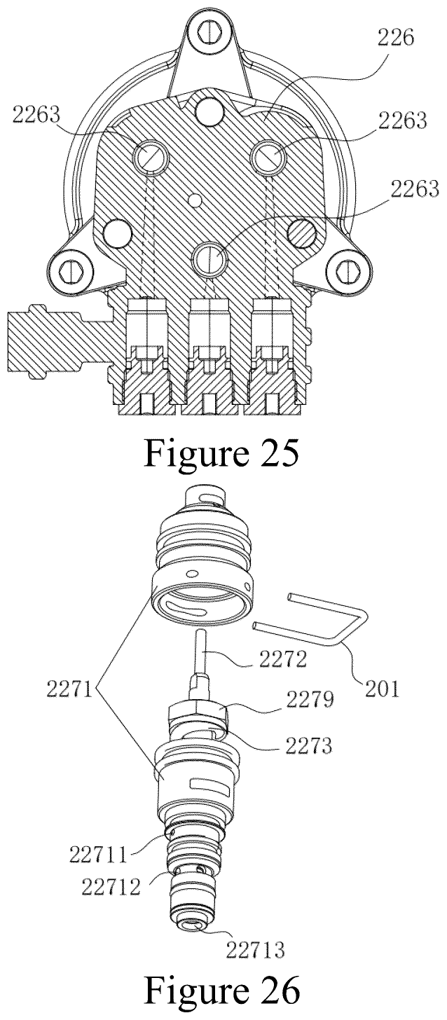

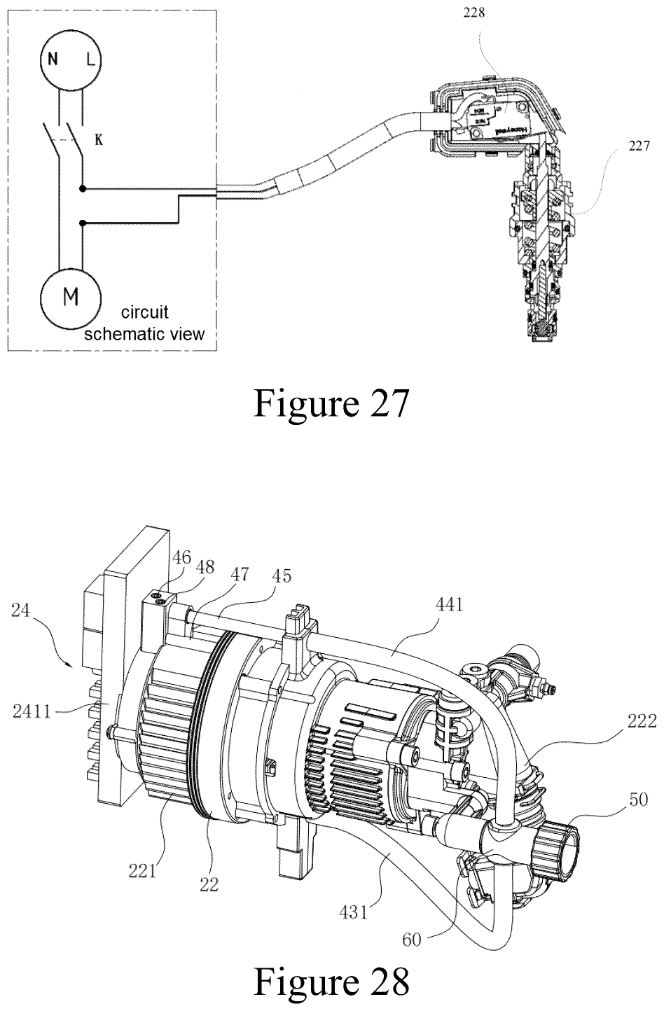

Please refer to FIG. 20 through FIG. 27 in conjunction with FIG. 13. The pump head assembly 222 includes a pump head 226, a jet release device and a gun-shutdown switch 2222, and the pump head 226 is configured to receive clean water flowing in from the second water inlet pipeline 224 and to increase a pressure. When the user does not start the pressure washer 100, an overflow valve rod (not shown) on the pump head 226 will press against the gun-shutdown switch 2222 to close it. When the user starts the pressure washer 100 for a normal operation, the overflow valve rod is always in a closed state, and when the user stops working and releases a trigger, the overflow valve rod will lose a contact with the gun-shutdown switch 2222, a power will be cut off and the machine will be shut down.

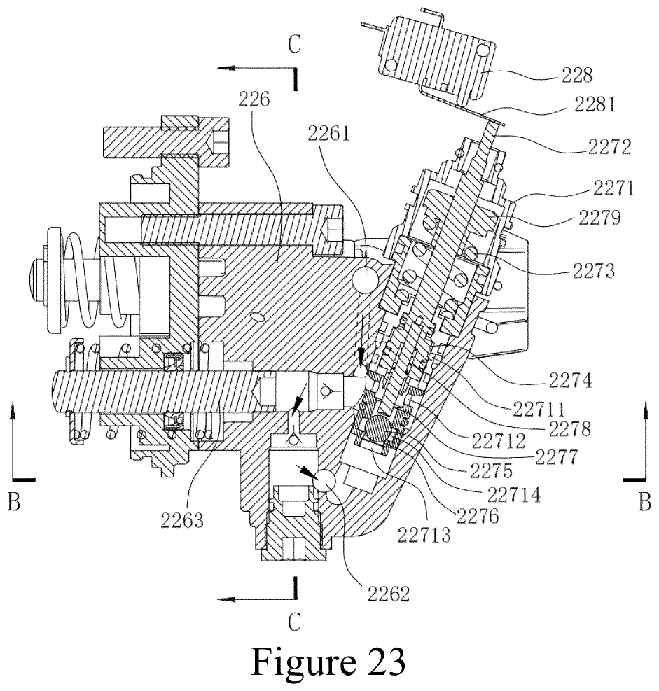

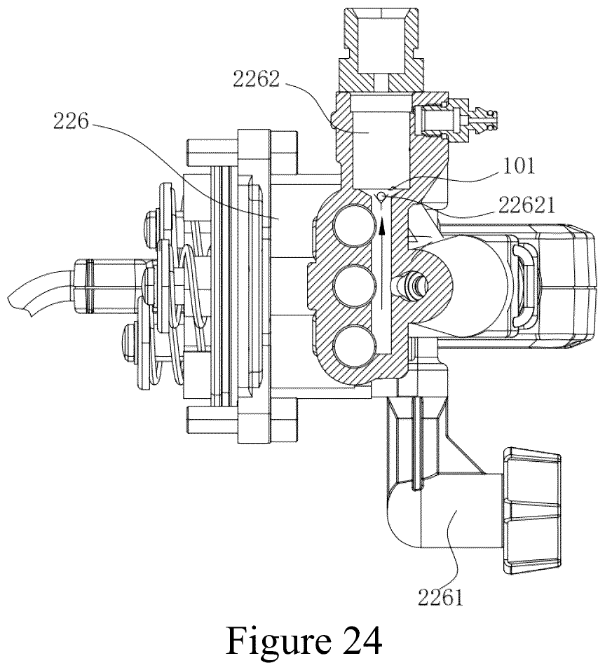

The pump head 226 is provided with a water inlet passage 2261, a water outlet passage 2262 and a pressurizing mechanism 2263. The pressurizing mechanism 2263 is located between the water inlet passage 2261 and the water outlet passage 2262, and is used to pressurize fluid in the water inlet passage 2261 and transport it to the water outlet passage 2262. The water outlet passage 2262 is provided with a one-way valve 22621. A direction indicated by straight arrows in FIG. 23 and FIG. 24 is a direction of water flow when the pump head 226 is in a normal working state. In this embodiment, the pressurizing mechanism 2263 is a reciprocating plunger. In FIG. 23, the plunger sucks the fluid in the water inlet passage 2261 into a plunger cavity by moving to left, and then squeezes the fluid to the water outlet passage 2262 by moving to right. In this process, a one-way stopping valve is respectively arranged at a water inlet and a water outlet of the plunger cavity. A position and a function of the one-way stopping valve and the one-way valve 22621 should be distinguished. The one-way stopping valve is to prevent the fluid from flowing back during a reciprocating motion of the plunger, while the one-way valve 22621 can prevent the high-pressure fluid in the jet release device from flowing back into the pump head 226.

It may be understood that, the jet release device may be a spraying gun and a pipe connected with the spraying gun, and the jet release device is communicated with the water outlet passage 2262. The jet release device is provided with a spraying head that can be opened or closed. When the spraying head is opened, the fluid in the water outlet passage 2262 can be discharged from the jet release device, so that the water outlet passage 2262 maintains a relatively constant pressure, and when the spraying head is closed, the fluid in the water outlet passage 2262 has nowhere to be released, so the pressure will gradually increase.

The gun-shutdown switch 2222 includes a gun-shutdown unloading valve, which includes a second valve body 227 and a switch unit 228. The second valve body 227 is communicated with the water outlet passage 2262 and matched with the switch unit 228. The second valve body 227 is configured so that when the pressure in the water outlet passage 2262 increases due to a closing of the jet release device, the second valve body 227 can drive the switch unit 228 to be disconnected so as to shut down the pressure washer 100, and when the pressure in the water outlet passage 2262 decreases due to the opening of the jet release device, the second valve body 227 can drive the switch unit 228 to be closed so as to start the pressure washer 100.

The second valve body 227 includes a valve sleeve 2271, a valve rod 2272 and a first elastic unit 2273. The valve sleeve 2271 may be formed by splicing a plurality of tubular objects. The tubular objects may be fixed by welding, threaded connection, or by positioning pins. The positioning pin includes a first U-shaped pin 201, one of the tubular objects is provided with two parallel inserting holes, and the other one of the tubular object is provided with a limiting groove. After the two tubular objects are inserted into each other, the first U-shaped pin 201 is inserted into the inserting hole. At this time, the first U-shaped pin 201 is accommodated in the limiting groove, thereby preventing the two tubular objects from separating from each other. This connection method is easy to install and disassemble, and is convenient for inspection and maintenance of the pressure washer 100.

Similarly, the valve sleeve 2271 and the pump head 226 may also be fixed by a positioning pin. For example, a pin hole for inserting a second U-shaped pin 229 is arranged on the pump head 226, and an inserting groove is arranged on an outer wall of the valve sleeve 2271. When the valve sleeve 2271 is installed on the pump head 226, the second U-shaped pin 229 is inserted into the pin hole. At this time, the second U-shaped pin 229 is just placed in the inserting groove, thereby limiting a relative displacement between the valve sleeve 2271 and the pump head 226.

The valve rod 2272 is movably arranged between a first station and a second station relative to the valve sleeve 2271. The first elastic unit 2273 is assembled so that an elastic force of the first elastic unit 2273 acts between the valve rod 2272 and the valve sleeve 2271 and the first elastic unit 2273 keeps the valve rod 2272 in the first station. A hydraulic cavity 2274 is formed between the valve rod 2272 and the valve sleeve 2271, the valve sleeve 2271 is provided with a first flow hole 22711 penetrating to the hydraulic cavity 2274, and an outer side of the first flow hole 22711 is communicated with the water outlet passage 2262 through an internal passage 101. When a fluid medium in the hydraulic cavity 2274 reaches a preset pressure, the valve rod 2272 can overcome the elastic force of the first elastic unit 2273 and move to the second station. The first flow hole 22711 is communicated with the water outlet passage 2262 downstream of the one-way valve 22621. The switch unit 228 is provided with a trigger part, the trigger part is configured to be triggered by the valve rod 2272, and when the valve rod 2272 switches between the first station and the second station, the trigger part can change an opening and a closing state of the switch unit 228.

In a specific embodiment, the switch unit 228 includes a micro switch, the trigger part includes a driving rod 2281 of the micro switch, and the valve rod 2272 abuts against the driving rod 2281. The driving rod 2281 and the valve rod 2272 are assembled so that when the valve rod 2272 is located at the first station, the micro switch is closed, and when the valve rod 2272 is located at the second station, the micro switch is disconnected.

Please refer to FIG. 23 and FIG. 26. The valve sleeve 2271 is provided with a second flow hole 22712 and a third flow hole 22713. An unloading valve core 2275 located between the second flow hole 22712 and the third flow hole 22713 is arranged inside the valve sleeve 2271, and the unloading valve core 2275 is coupled to the valve rod 2272. When the valve rod 2272 is located at the first station, the unloading valve core 2275 remains in the closed state, and when the valve rod 2272 moves from the first station to the second station, the unloading valve core 2275 can be switched to the open state. The second flow hole 22712 is communicated with the water inlet passage 2261, and the third flow hole 22713 is communicated with the water outlet passage 2262 upstream of the one-way valve 22621.

It may be understood that, when the valve rod 2272 disconnects the switch unit 228, the unloading valve core 2275 can be opened. At this time, an upstream of the water outlet passage 2262 is communicated with the water inlet passage 2261, thereby realizing a pressure relief on the upstream of the water outlet passage 2262. In this way, when the pressure washer 100 is shut down, the pump head 226 can be placed in a low-pressure environment, thereby avoiding damage to sealing components caused by high pressure and increasing duration lives.

Please refer to FIG. 23. An annular groove 22714 is arranged on an inner wall of the valve sleeve 2271, the second flow hole 22712 and the third flow hole 22713 are respectively located at two ends of the annular groove 22714, and the unloading valve core 2275 is located in the annular groove 22714. A second elastic unit 2276 is arranged on a side of the unloading valve core 2275 away from the valve rod 2272, and the second elastic unit 2276 is configured so that an elastic force of the second elastic unit 2276 can drive the unloading valve core 2275 to attach to a groove wall of the annular groove 22714 close to the valve rod 2272 to block a flow passage between the second flow hole 22712 and the third flow hole 22713. A valve needle 2277 is arranged on one end of the valve rod 2272 facing the unloading valve core 2275. When the valve rod 2272 moves from the first station to the second station, the valve needle 2277 can drive the unloading valve core 2275 to separate from the groove wall of the annular groove 22714 to communicate the flow passage between the second flow hole 22712 and the third flow hole 22713. In a specific embodiment, the valve needle 2277 is movably connected with the valve rod 2272 along an axis direction, and a third elastic unit 2278 is arranged between the valve needle 2277 and the valve rod 2272 to buffer the unloading valve core 2275. The unloading valve core 2275 may be the steel ball.

Please refer to FIG. 26. In a specific embodiment, the second valve body 227 further includes a pressure-adjusting nut 2279, the pressure-adjusting nut 2279 is threadedly connected with the valve rod 2272, and the first elastic unit 2273 includes a compression spring arranged between the valve sleeve 2271 and the pressure-adjusting nut 2279. It may be understood that, in this embodiment, a pre-tightening force of the first elastic unit 2273 may be adjusted by changing a screwing depth of the pressure-adjusting nut 2279, thereby adjusting a pressure required to trigger the micro switch.

Combined with the above description, a working principle of the pump head assembly 222 is that when the spraying gun is closed, a pressure downstream of the water outlet passage 2262 increases, thereby driving the second valve body 227 to operate, the second valve body 227 drives the switch unit 228 to operate, and the switch unit 228 disconnects the circuit, thereby shutting down the pressure washer 100. Due to the one-way valve 22621, even if the pressure washer 100 is shut down, the downstream of the water outlet passage 2262 can still be maintained in a high pressure state, thereby keeping the switch unit 228 disconnected. When the spraying gun is turned on again, the pressure downstream of the water outlet passage 2262 is first released, at this time the second valve body 227 and the switch unit 228 are reset, the circuit is turned on again, and the pressure washer 100 is started.

Please refer to FIG. 12. Installation positions and methods of each electrical component inside the power head assembly 20 are shown. In this application, four battery packs 231 of 80 V are used as a design basis. In order to ensure a battery life of the pressure washer 100, a gun-shutdown switch (Pump switch) is arranged on the motor pump assembly 22. When the user does not start the pressure washer 100, an overflow valve rod (not shown) on the pump head will press against the gun-shutdown switch to close it. When the user starts the pressure washer 100 for a normal operation, the overflow valve rod is always in the closed state. When the user stops working and releases a trigger of the high-pressure water gun, the overflow valve rod will lose a contact with the gun-shutdown switch, a power will be cut off and the machine will be shut down.

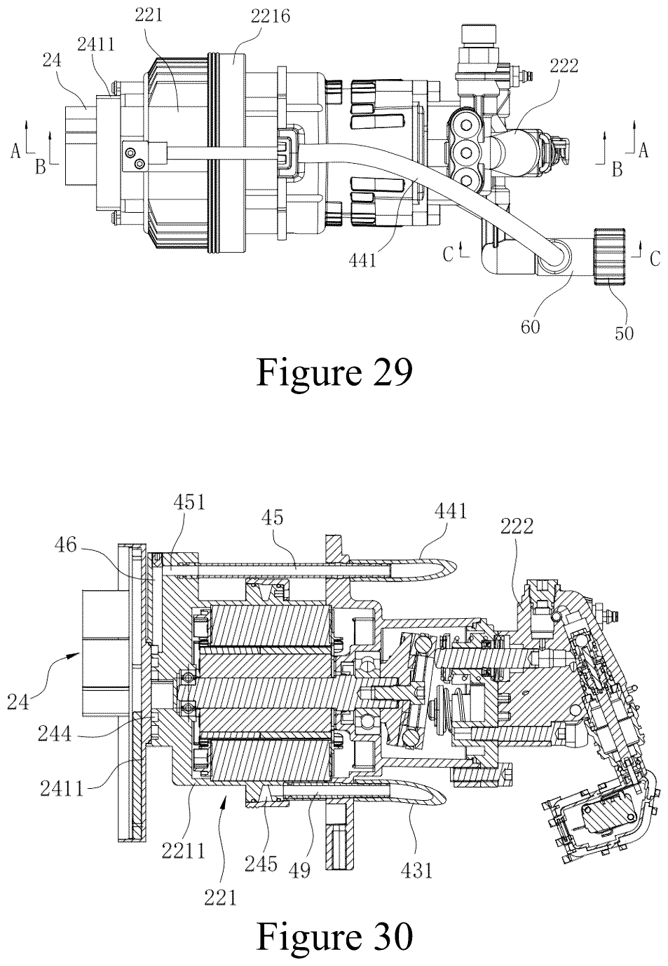

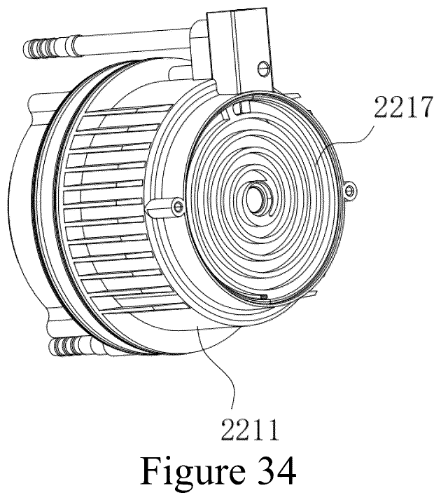

Please refer to FIG. 28 through FIG. 35. They show a third embodiment of the motor pump assembly 22. In this embodiment, the brushless motor 221 and the driving assembly 24 are used to further improve a rated power of the brushless motor 221, so that the motor pump assembly 22 can output a higher pressure and flow when working, and an operating state of the motor pump assembly 22 under different operating states is adjusted through the driving assembly 24 to improve the user experience. The brushless motor 221 of the disclosure may operate in a constant power state set by the driving assembly 24. When the motor pump assembly 22 switches to use spray nozzles of different diameters, the driving assembly 24 may control a rotating speed of the brushless motor 221 to achieve complementary changes in the pressure and flow of the motor pump component 22, so as to maintain an overall load power working in the set constant power state.

An annular protruding part 2214 is formed on the outer housing 2211 of the brushless motor 221 along a circumferential direction, and a concave groove 2215 is arranged on the annular protruding part 2214. An annular cover casing 2216 is arranged on an outer side of the annular protruding part 2214, and the cover casing 2216 closes a notch of the concave groove 2215 to form the second cooling passage 245. In this embodiment, corresponding sealing measures may be taken between the cover casing 2216 and the annular protruding part 2214. For example, a sealing ring is arranged between the cover casing 2216 and the annular protruding part 2214. In order to facilitate the connection between the cover casing 2216 and the annular protruding part 2214, a corresponding protruding flange may be arranged at one end of the cover casing 2216, and the protruding flange may be connected with a side wall of the annular protruding part 2214 by bolts.

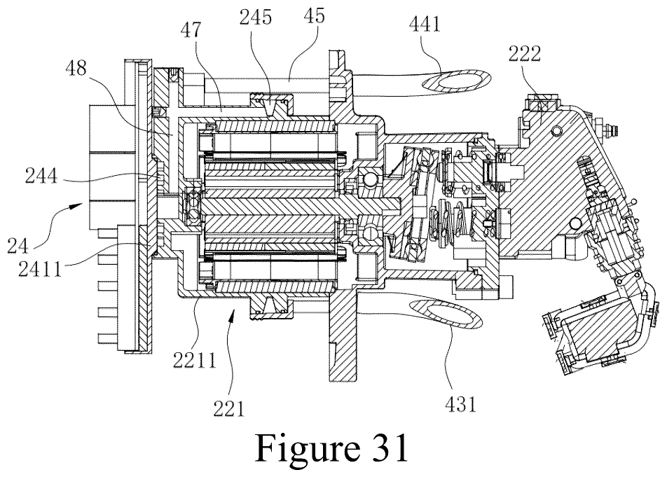

Please refer to FIG. 30 and FIG. 31. The driving assembly 24 is arranged at one end of an axial direction of the brushless motor 221, and the first cooling passage 244 is arranged close to the heat sink 2411. In some embodiments, the heat sink 2411 should be in contact with heating elements (such as MOS transistor) on the driving assembly 24 as much as possible to improve heat dissipation efficiency.

Please refer to FIG. 30 through FIG. 34. The first cooling passage 244 is arranged in a spiral shape along a surface of the heat sink 2411. In an embodiment, the outer housing 2211 is provided with a spiral groove 2217, and the spiral groove 2217 is closed by the heat sink 2411 to form the first cooling passage 244. It may be understood that, the first cooling passage 244 of the disclosure may also be arranged in other ways, as long as the first cooling passage 244 may be distributed as evenly as possible on the heat sink 2411, for example, the first cooling passage 244 is arranged in a continuous S-shape.

In this embodiment, a spiral flow passage 2413 with a same direction as the spiral first cooling passage 244 is arranged on the surface of the heat sink 2411. When these two flow passages are working, the heat transferred to the surface of the heat sink 2411 may be taken away as much as possible, thereby further improving cooling efficiency. It may be understood that, the first cooling passage 244 of the disclosure is as close to a position of the heating element as possible, and a position of the first cooling passage 244 is not necessarily located at a geometric center of the heat sink 2411, and may be arranged at an eccentric position.

A first end of the second cooling passage 245 is communicated with the water inlet connector 50, a second end of the second cooling passage 245 is communicated with a first end of the first cooling passage 244, and a second end of the first cooling passage 244 is communicated with the water inlet 2221 of the pump head assembly 222. An axis of the brushless motor 221 is arranged horizontally, the water inlet connector 50 is communicated with a lower end of the second cooling passage 245, and an upper end of the second cooling passage 245 is communicated with the first cooling passage 244. In this embodiment, the second cooling passage 245 and the first cooling passage 244 are connected in series in sequence, and working fluid first passes through the second cooling passage 245 and then passes through the first cooling passage 244.

It may be understood that, a water inlet of the second cooling passage 245 is located at a bottom, and a water outlet of the second cooling passage 245 is located at a top. The cooling water fills an annular water cavity from bottom to top, and the air in the cavity may be completely exhausted. Therefore, when the motor pump assembly 22 is working, the residual air in the flow passage will not cause the pump to vibrate, which is beneficial for emptying the air in the flow passage as soon as possible when the motor pump assembly 22 is in a self-suction working state, so that the machine can work quickly and stably.

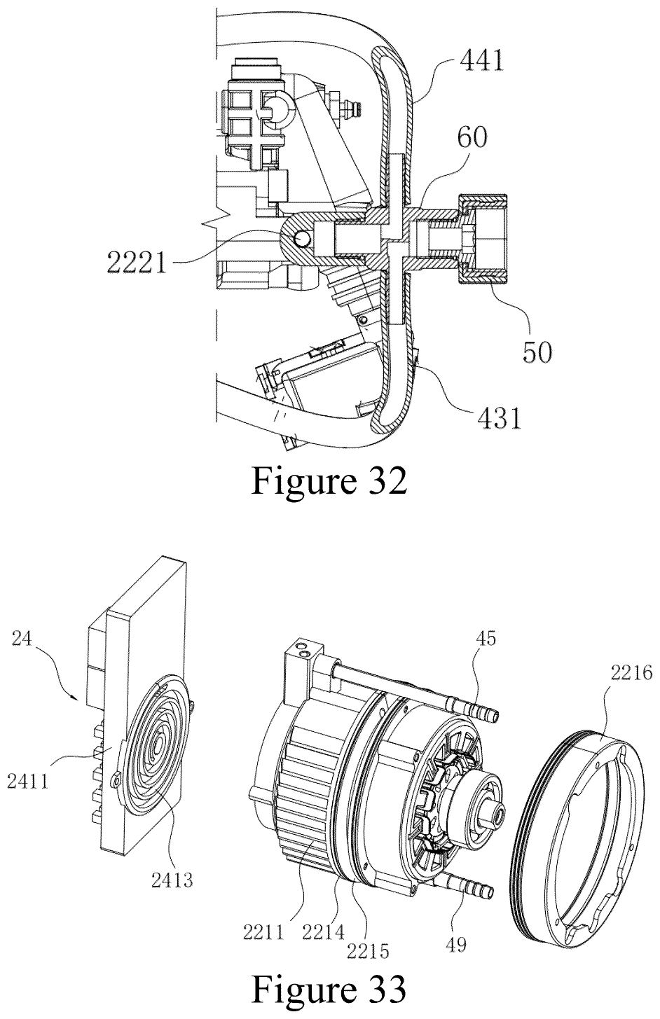

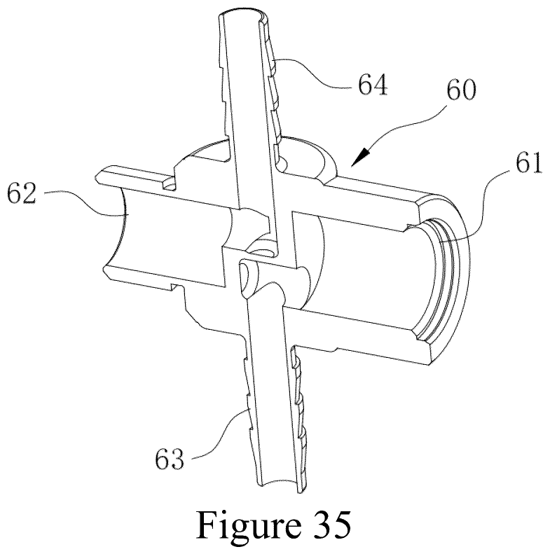

Please refer to FIG. 32, FIG. 33 and FIG. 35. The water inlet 2221 is installed with an adapter 60, and the adapter 60 is provided with a first port 61, a second port 62, a third port 63 and a fourth port 64, wherein the first port 61 and the third port 63 are communicated from an inside of the adapter 60, and the second port 62 and the fourth port 64 are communicated from the inside of the adapter 60. The water inlet connector 50 is installed on the first port 61. The third port 63 is communicated with a lower end of the second cooling passage 245 through a first pipe. The second port 62 is communicated with the water inlet 2221. The fourth port 64 is communicated with the first cooling passage 244 through a second pipe. An interior of the adapter 60 is designed to be two independent isolated water passages, namely the water entering passage and the water returning passage. The water entering passage and the water returning passage are respectively connected with the external water source and the pump head assembly 222. The water source enters the brushless motor 221, the driving assembly 24 and a cooling system of a connecting pipeline from the water entering passage, and then returns to the water returning passage to be injected into the pump head assembly 222.

It may be understood that, the disclosure arrange the adapter 60 at the water inlet 2221. During the use of the motor pump assembly 22, installation habits of the motor pump assembly 22 are consistent with installation habits of the conventional motor pump assembly. The user does not need to pay additional learning costs due to a change of the water passage, which further improves the user experience.

Please refer to FIG. 30 through FIG. 32. The first pipeline includes a first hose 431 and a first pipe connector 49. The first pipe connector 49 is installed at a lower end of the second cooling passage 245. The first hose 431 is connected between the first pipe connector 49 and the second port 62. The second pipeline includes a second hose 441 and a second pipe connector 45. The second pipe connector 45 is installed at an upper end of the brushless motor 221. One end of the second pipe connector 45 is connected with the first cooling passage 244 through a first radial hole 46 opened at a rear end of the brushless motor 221. The second hose 441 is connected between the second pipe connector 45 and the fourth port 64.

In an embodiment, an upper end of the outer housing 2211 is provided with a first axial hole 451 and a second axial hole 47, and a rear end of the outer housing 2211 is provided with the first radial hole 46 and a second radial hole 48. A first end of the second radial hole 48 is communicated with the second axial hole 47, and the second axial hole 47 is communicated with the upper end of the second cooling passage 245. A second end of the second radial hole 48 is communicated with a spiral flow passage of the first cooling passage 244. A first end of the first axial hole 451 is communicated with a tail end of the spiral flow passage of the first cooling passage 244 through the first radial hole 46, and a second end of the first axial hole 451 is communicated with the second pipe connector 45.

In this embodiment, a cross-section of the second cooling passage 245 is a trapezoid. An cross-sectional area of the second cooling passage 245 is designed to be 2 to 3 times a cross-sectional area of the first pipe connector 49, and a diameter of the flow passage of the first pipe connector 49 should be no less than 5 mm so as not to affect water inlet efficiency of the motor pump assembly 22 when pumping water. This design may increase a contact area of the cooling water as much as possible while reducing an empty volume on the first pipe connector 49, so as to achieve a good cooling effect. A cross-section of the first cooling passage 244 is rectangular, an cross-sectional area of the first cooling passage 244 is designed to be 1 to 2 times a cross-sectional area of the second radial hole 48, and a diameter of the flow channel of the second pipe connector 45 should be not less than 5 mm so as not to affect the water inlet efficiency of the motor pump assembly 22 when pumping water. The cooling water flows in one direction along the spiral water cavity, there is no water accumulation in the space of the water cavity, and the heat sink 2411 will not be overheated due to uneven cooling.

In other embodiments, the annular water cavity of the brushless motor 221 and the spiral water cavity of the driving assembly 24 may also be designed based on a heat generation comparison between the brushless motor 221 and the driving assembly 24. A heat generation ratio is generally 3:1. In addition, based on an influence of the annular water passage on the heat sink 2411 on a distribution positions of the heating elements, a ratio of a direct cooling contact surface area of the annular water cavity to a direct cooling contact surface area of the heat sink 2411 should be greater than 2:1, and a minimum area should be greater than 5000 square millimeters.

Please refer to FIG. 1 and FIG. 2. The upper bracket assembly 30 includes an upper bracket 31, a sponge sleeve 32 sleeved on the upper bracket 31, an installation panel 33 fixed on the upper bracket 31, and a gun hanger 34 and a high-pressure pipe hook 35 hung on the upper bracket 31. Wherein, the upper bracket 31 and the lower bracket 11 are assembled and fixed by assembling knobs 36 and screws 37. The sponge sleeve 32 is arranged in a middle position of the upper bracket 31, which is convenient for the user to hold and operate the pressure washer 100. The installation panel 33 is connected with the upper bracket 31, the gun hanger 34 is fixed to a side of the upper bracket 31 and extends outward, and the high-pressure pipe hook 35 is fixed to a side of the installation panel 33 facing the user, which is convenient for the user to hang or take out the high-pressure water pipe 44.

The washing assembly 40 includes a water gun handle 41, the gun barrel assembly 42, the spray nozzle 43 for various purposes and the high-pressure water pipe 44. Wherein the water gun handle 41 is used for the user to hold, the gun barrel assembly 42 is connected with the water gun handle 41, and the spray nozzle 43 is used to be installed at a tail end of the gun rod assembly 42 to perform cleaning actions for various purposes, which provides different accessory options for various usage conditions of the pressure washer 100. The high-pressure water pipe 44 is connected between the water outlet end of the pump head assembly 222 and the gun barrel assembly 42 to output the external water source to the gun barrel assembly 42 and the spray nozzle 43 for cleaning. Spray nozzles 43 for various purposes are all installed on the installation panel 33, which enables it to be convenient for users to select. The water gun handle 41 is hung on the gun hanger 34, and the high-pressure water pipe 44 is hung on the high-pressure pipe hook 35, so that the high-pressure water pipe 44 may be easily taken out.

In summary, an arrangement of the upper bracket assembly 30 can not only provide a movable towing armrest for the entire pressure washer 100, but also provide the installation positions for various accessories of the pressure washer 100 (such as the high-pressure water pipe 44, the spray nozzle 43, and the water gun handle 41).

The power head assembly 20 of the disclosure can be installed in an independent and movable manner, and may be arranged on a frame-type bracket, or placed on a walking wheeled vehicle (such as a tricycle, a sanitation vehicle, a station wagon, etc.) as a cleaning tool that may be used at any time.

Compared with the prior art, the power head assembly 20 and the pressure washer 100 of the disclosure have following advantages as follows.

1. The power head assembly 20 is capable of performing efficient cleaning tasks under high power, high water pressure and high flow states in various conditions, and may achieve a cleaning ability of a general gasoline pressure washer. The working pressure is generally greater than 13 MPa, and the flow rate is greater than 480 L/H, which is a first high-water-pressure, high-flow DC pressure washer on the market, a DC electric pressure washer product that may basically replace gasoline pressure washers, and may meet users' needs for higher cleaning capabilities in conditions without AC power.

2. An integrated water-cooling structure is adopted for the brushless motor 221 and the water-cooled driver 241, and the brushless motor 221 and the water-cooled driver 241 are cooled simultaneously by a series cooling passage, which reduces power consumption of the brushless motor 221 and improves the efficiency, so that the brushless motor 221 and the water-cooled driver 241 can work more safely and efficiently.

3. Through integrating the housing assembly 21, the motor pump assembly 22, the battery pack assembly 23 and the driving assembly 24 into a whole, the power head assembly 20 is designed into an independently movable power head assembly, which has a compact structure, a beautiful appearance and a small size, but also may be installed on different applications at any time to meet various needs depending on the usage conditions, thereby expanding a scope of use.

4. By using the battery pack assembly 23 including multiple battery packs 231 as a DC power supply, power may be supplied to the outside in a parallel combination or a series-parallel combination. Moreover, when the battery pack 231 is exhausted, a fully charged battery pack 231 may be quickly replaced, thereby solving a power endurance problem when the user uses it.

5. The first water inlet connector 2231 is designed to be connected with a hose, so that the first water inlet connector 2231 may be designed at any position of the housing assembly 21, and then connected with the cooling passage through a hose connection, and an overall structural design of the pressure washer 100 is more adaptable.

6. By adding a mode switch 2122 to the upper housing 212, the battery life of the pressure washer 100 may be increased, and multiple working modes of short-term high-power and efficient operation may be provided, which provides more choices for users.

In summary, the power head assembly 20 of the disclosure not only improves the total power and the operating time by configuring the battery pack assembly 23 to include at least two battery packs 231 connected in series or in parallel, but also may further improve the battery life by replacing the battery pack 231. In addition, through integrating the housing assembly 21, the motor pump assembly 22, the battery pack assembly 23 and the driving assembly 24 into a whole, the power head assembly 20 is designed into an independently movable power head assembly 20, which not only has a compact structure and is easy to install, but also has superior performance, is easy to use, and has strong mobility, so that it may be installed on different applications at any time to meet various needs depending on the usage conditions, thereby expanding the scope of use.

The above embodiments are only used to illustrate the technical solution of the disclosure and are not intended to limit it. Although the disclosure has been described in detail with reference to the preferred embodiments, a person skilled in the art should understand that the technical solution of the disclosure may be modified or replaced by equivalents without departing the disclosure.

What is claimed is:

1. A pressure washer, comprising a lower bracket assembly, an upper bracket assembly extending upward from the lower bracket assembly, a power head assembly fixed on the lower bracket assembly, and a washing assembly connected with the upper bracket assembly, wherein the power head assembly comprises:
a housing assembly, the housing assembly comprising a lower housing, an upper housing assembled with the lower housing, a battery pack cavity at least partially accommodated in the upper housing and a cover covering a top of the battery pack cavity;
a motor pump assembly, the motor pump assembly accommodated in a first accommodating cavity formed by assembling the upper housing and the lower housing;
a battery pack assembly, the battery pack assembly accommodated in the battery pack cavity, the battery pack cavity comprising at least two battery packs connected in series or in parallel, and
a driving assembly, the driving assembly comprising a water-cooled driver and a circuit controller, the water-cooled driver electrically connected with the motor pump assembly in the lower housing to drive the motor pump assembly to work, and the circuit controller electrically connected with the battery pack assembly to access a power of each battery pack and distribute the power to the water-cooled driver.

2. The pressure washer according to claim 1, wherein, the upper housing and the lower housing are further assembled to form a second accommodating cavity and a third accommodating cavity, the battery pack cavity is accommodated in the second accommodating cavity and the third accommodating cavity to accommodate the at least two battery packs, the first accommodating cavity is located between the second accommodating cavity and the third accommodating cavity, the battery pack cavity comprises a first accommodating part accommodated in the second accommodating cavity, a second accommodating part accommodated in the third accommodating cavity, and a connecting part connecting the first accommodating part and the second accommodating part, and the first accommodating cavity is formed below the connecting part and separates the first accommodating part from the second accommodating part.

3. The pressure washer according to claim 1, wherein, a power switch and a mode switch are arranged at a middle position of the upper housing, the power switch is configured to control an on-off of the power head assembly, and the mode switch is configured to provide a variety of working modes to the power head assembly, the working modes comprise an energy-saving mode and/or a high-power mode.

4. The pressure washer according to claim 1, wherein, there are two covers and the covers are respectively installed in a flipping manner on two side edges of the upper housing, each of the covers is provided with a flipping rotation shaft and flipping springs sleeved on both ends of the flipping rotation shaft, when the cover is opened, the flipping rotation shaft rotates synchronously and causes the flipping spring to be stretched, and after the cover is released, the flipping spring drives the cover to close automatically.

5. The pressure washer according to claim 4, wherein, a first pressing block and a second pressing block are arranged at a center position of the flipping rotation shaft, a damper and a power-off switch are correspondingly arranged in the upper housing, the first pressing block is configured to preferentially contact the damper when the cover is automatically closed, and the second pressing block is configured to abut against the power-off switch to turn on the power-off switch when the cover is in a closed state and configured to be disconnected from the power-off switch to turn off the power-off switch when the cover is in an open state.

6. The pressure washer according to claim 1, wherein, the motor pump assembly comprises a brushless motor, a pump head assembly connected with the brushless motor, and a first water inlet pipeline and a second water inlet pipeline connected with two ends of the brushless motor, the first water inlet pipeline is arranged away from the pump head assembly to connect with external water, and the second water inlet pipeline connects the brushless motor with the pump head assembly on a side of the brushless motor close to the pump head assembly.

7. The pressure washer according to claim 6, wherein, the water-cooled driver is electrically connected with the brushless motor on one side of the first water inlet pipeline, a cooling passage is formed inside the brushless motor, and the cooling passage flows through the water-cooled driver and the brushless motor at the same time, so that the external water enters through the first water inlet pipeline, passes through the cooling passage first, and then flows into the pump head assembly from the second water inlet pipeline.

8. The pressure washer according to claim 7, wherein, the cooling passage comprises a first cooling passage formed between the water-cooled driver and the brushless motor and a second cooling passage located inside the brushless motor, the second cooling passage communicates the first cooling passage with the second water inlet pipeline, the first cooling passage is arranged in a spiral shape, and the second cooling passage is arranged in a ring shape.

9. The pressure washer according to claim 1, wherein, the motor pump assembly comprises a brushless motor, the brushless motor comprises an outer housing, a stator assembly and a rotor assembly, the stator assembly and the rotor assembly are arranged in the outer housing, the outer housing is sealed, an accommodating space is formed in the outer housing, and the accommodating space contains insulating liquid to absorb heat generated by the brushless motor and transfer the heat to an outer surface of the outer housing.

10. The pressure washer according to claim 9, wherein, a volume of the insulating liquid accounts for 95% or more of a volume of the accommodating space.

11. The pressure washer according to claim 9, wherein, the brushless motor further comprises an exhaust valve, the exhaust valve is arranged on the outer housing and communicated with the accommodating space, and a valve port for the exhaust valve is arranged on the outer housing.

12. The pressure washer according to claim 11, wherein, the exhaust valve comprises a first valve body, a first sealing ring, a second sealing ring, a steel ball and an elastic component, the first valve body is embedded in the valve port, the first sealing ring is sleeved on an outside of the first valve body to seal and connect the first valve body with the outer housing, the steel ball is arranged inside the first valve body, the second sealing ring is located between the steel ball and the first valve body to seal an internal space of the first valve body, and the elastic component abuts against the steel ball along an exhaust direction of the exhaust valve.

13. The pressure washer according to claim 6, wherein, the pump head assembly comprises a pump head and a gun-shutdown switch, and the pump head is configured to receive clean water flowing in from the second water inlet pipeline and to increase a pressure.

14. The pressure washer according to claim 13, wherein, the gun-shutdown switch comprises a gun-shutdown unloading valve, and the gun-shutdown unloading valve comprises:
a second valve body, the second valve body comprising a valve sleeve and a valve rod, the valve rod being movably arranged relative to the valve sleeve between a first station and a second station;
a first elastic unit, the first elastic unit configured such that an elastic force pf the first elastic unit acts between the valve rod and the valve sleeve and keeps the valve rod in the first station;
a hydraulic cavity formed between the valve rod and the valve sleeve, a first flow hole penetrating to the hydraulic cavity arranged on the valve rod, when fluid medium in the hydraulic cavity reaches a preset pressure, the valve rod capable of overcoming the elastic force of the first elastic unit and moving to the second station; and
a switch unit, the switch unit provided with a trigger part, the trigger part configured to be triggered by the valve rod, and when the valve rod switches between the first station and the second station, the trigger part capable of changing an open state and a closed state of the switch unit.

15. The pressure washer according to claim 14, wherein, the valve sleeve is provided with a second flow hole and a third flow hole, an unloading valve core located between the second flow hole and the third flow hole is arranged inside the valve sleeve, the unloading valve core is coupled to the valve rod, when the valve rod is located at the first station, the unloading valve core remains in a closed state, and when the valve rod moves from the first station to the second station, the unloading valve core can be switched to an open state.

16. The pressure washer according to claim 15, wherein, an annular groove is arranged on an inner wall of the valve sleeve, the second flow hole and the third flow hole are respectively located at two ends of the annular groove, the unloading valve core is located in the annular groove, a second elastic unit is arranged on a side of the unloading valve core away from the valve rod, the second elastic unit is configured so that an elastic force of the second elastic unit is driving the unloading valve core to cling to a groove wall of the annular groove close to the valve rod so as to block a flow passage between the second flow hole and the third flow hole, a valve needle is arranged on an end of the valve rod facing the unloading valve core, and when the valve rod moves from the first station to the second station, the valve needle is capable of driving the unloading valve core to be separated from the groove wall of the annular groove so as to communicate the flow passage between the second flow hole and the third flow hole.

17. The pressure washer according to claim 16, wherein, the valve needle is movably connected with the valve rod along an axis direction thereof, and a third elastic unit is arranged between the valve needle and the valve rod.

18. The pressure washer according to claim 14, wherein, the switch unit comprises a micro switch, the trigger part comprises a driving rod of the micro switch, the valve rod abuts against the driving rod, and the driving rod and the valve rod are assembled so that when the valve rod is located at the first station, the micro switch is closed, and when the valve rod is located at the second station, the micro switch is disconnected.
